(19) United States
(12) Patent Application Publication
(10) Pub. No.: US 2026/0241957 A1
(43) Pub. Date: Aug. 20, 2026

(54) RESOLVING VEHICLE HEADING

(71) Applicant: Pony.ai, Inc., Fremont, CA (US)

(72) Inventor: Mengda Yang, Mountain View, CA (US)

(21) Appl. No.: 19/058,237

(22) Filed: Feb. 20, 2025

(51) Int. Cl. B60W 60/00; G06V 20/56

(52) U.S. Cl. CPC B60W 60/0015; G06V 20/588; B60W 2420/403; B60W 2552/53; B60W 2556/10; B60W 2556/20

(57) ABSTRACT

A computing system includes one or more processors that obtaining different iterations of lane indicia data; obtain localization results comprising poses of an ego vehicle corresponding to each of the different iterations; characterize the different iterations of the lane indicia data; selectively qualify the different iterations of the lane indicia data; for each qualified iteration, generating a lane representation based on the lane indicia data, project the lane representation into a different coordinate system and project the localization result into the different coordinate system; and for a pair of qualified iterations, iteratively determine, based on a function, a rotation angle of a first lane representation corresponding to the first qualified iteration with respect to a second lane representation corresponding to the second qualified iteration, and resolve the localization result based on the result of the rotation.

### BACKGROUND

The meteoric rise in deployment of autonomous or semi-autonomous vehicles has been a catalyst that has ushered in a new era of mobility. Ensuring the safety, efficiency, and reliability of these vehicles is a paramount priority. By 2040, an anticipated 75 percent of vehicles will be autonomous or semi-autonomous, according to the Institute of Electrical and Electronics Engineers (IEEE). According to current estimates, approximately 9.1 autonomous or semi-autonomous vehicle crashes occur per million miles driven. From June 2021 to June 2024, 3,979 incidents involving Society of Automotive Engineers (SAE) Level 2 or higher vehicles were reported to the National Highway Traffic Safety Administration (NHTSA).

One aspect of vehicle safety is determining, confirming, and/or resolving an accurate vehicle heading during navigation. Confirming an appropriate vehicle heading may be a sanity check to ensure that a vehicle is safely following a planned navigation path. Even slight errors in vehicle heading may detrimentally increase a probability of a disengagement or accident during navigation.

### SUMMARY

A computing system associated with an ego vehicle resolves vehicle heading or orientation (hereinafter “heading”). A heading may refer to a direction that the ego vehicle is facing. The facing direction may include a direction with respect to a yaw component (e.g., with respect to true north). In some embodiments, an ego vehicle may refer to an autonomous vehicle, a semi-autonomous vehicle, or any other type of vehicle.

An existing technical problem includes an inability to accurately and efficiently determine, confirm, and/or resolve (hereinafter “resolve”) a heading of an ego vehicle, especially when certain ego vehicle-related parameters of an ego vehicle change, are inaccurate, and/or are uncalibrated. This inability may detrimentally increase a probability of a disengagement or accident during navigation.

In some embodiments, an uncalibrated parameter may refer to an actual measurement of a parameter deviating from a previously calibrated measurement of the parameter. In some embodiments, an inaccurate parameter may include inaccurate measurements of an extrinsic. In some embodiments, the extrinsic may refer to a pose difference, which may include a difference in position (e.g., distance) and/or orientation (e.g., angle) in any of three dimensions between a rear axle of the ego vehicle and a center of an inertial measurement unit (IMU). A rear axle is part of, or connected with, a chassis, while the IMU is mounted within the body. The chassis and the body are connected by suspension springs. Inaccuracy of the extrinsic may be attributed to displacement of the body relative to the chassis. Causes of this displacement may include vibration of the ego vehicle, changes in occupants within a cabin of the ego vehicle, maintenance, and/or other changes in weight and/or force distribution within the ego vehicle.

Embodiments of the present invention overcome these aforementioned bottlenecks. The computing system resolves vehicle heading even when certain vehicle-related parameters are changing, inaccurate and/or uncalibrated. The computing system resolves vehicle heading using a Global Navigation Satellite System (GNSS), Real-Time Kinematic (RTK), and lane detection. In some embodiments, lane detection may include detection of lane indicia which indicate or are likely to indicate lane boundaries or lane lines (hereinafter “lane boundaries”) or portions thereof. In some embodiments, being likely to indicate may refer to a lane indicia exceeding a threshold probability of being or indicating lane boundaries. As nonlimiting examples, lane boundaries may refer to markings including solid white lines separating traffic traveling in a same direction, yellow lines separating traffic traveling in different directions, broken lines which are crossable, edge lines that separate a road from a shoulder, or portions thereof. In some embodiments, lane indicia may include points or positions, each of which may correspond to different spatial coordinates. The spatial coordinates may be defined within a sensor coordinate system of a sensor that detected the lane indicia.

Although the foregoing focuses on lane detection, the disclosure is not intended to be limited to such. For example, detection of other indicia may be used in place of, or in addition to, lane detection. Other indicia may include any features of a geometry of a road, including physical barriers such as center dividers, curbs, railings, and/or other barriers, and/or other stationary objects on a road.

In some embodiments, the computing system may periodically and/or iteratively resolve a heading of the ego vehicle while the ego vehicle is in motion. In some embodiments, a frequency and/or time periods at which the heading is resolved may be same as or different from a frequency and/or time periods at which the perception sensors detect lane indicia. In some embodiments, the computing system may resolve a heading at certain fixed time intervals. In some embodiments, the computing system may adjust a frequency and/or time periods at which the heading is resolved based on environmental conditions such as weather, visibility, traffic conditions such as a density of traffic, a location, or a road geometry through which the ego vehicle is traversing. For example, if weather conditions are rainy, visibility is limited, density of traffic is high (e.g., outside of respective thresholds), and/or if a road geometry includes a high density of curves, then the computing system may resolve the heading at higher frequencies.

In some embodiments, one or more perception sensors associated with the computing system periodically and/or iteratively detect lane indicia. At each iteration, or time instance, the perception sensors may obtain one or more records or frames that contain lane indicia indicate of, or have at least a threshold probability of indicating, lane indicia. In some embodiments, as previously mentioned, lane indicia may include indicators of a lane such as portions of a lane boundary. In some embodiments, within a single record, each instance of lane indicia may correspond to one or more three-dimensional (3-D) coordinates, or have coordinates up to three dimensions, and/or may be detected relative to a sensor coordinate system. The sensor coordinate system may be relative to a rear axle of the ego vehicle. In some embodiments, at each iteration, the computing system may also obtain one or more localization results including poses of the ego vehicle. In some embodiments, the computing system may obtain the localization results from a different computing module.

The computing system may obtain a most recent iteration or current iteration (hereinafter “current iteration”) of detected lane indicia. Each iteration may be recorded by timestamps corresponding to the iterations which indicate a time of capture. Such detected lane indicia corresponding to the current iteration may be referred to as current lane indicia. The computing system may obtain or retrieve one or more previous iterations prior to the current iteration. The computing system may characterize and/or qualify or validate (hereinafter “qualify”) the current iteration. In some embodiments, characterizing may include determining whether the lane indicia of the current iteration, considered in its entirety, constitute a sufficiently straight line segment when connected, and/or are sufficiently fittable to a straight line segment (e.g., a connecting segment). The computing system may selectively qualify and/or retain the current iteration based on whether the current iteration constitutes a sufficiently straight segment. The computing system may retain the current iteration if the current iteration is deemed to be qualified, or in other words, if the current iteration constitutes a straight segment. Otherwise, the computing system may discard or disregard the current iteration.

In some embodiments, previous iterations may already have been characterized and/or qualified. Alternatively, if previous iterations have not already been characterized and qualified, the computing system may perform an analogous process with respect to any previous iterations. In some embodiments, the qualification process for previous iterations may include determining, for lane indicia in each previous iteration, whether the lane indicia constitute a sufficiently straight line segment, and/or are sufficiently fittable to a straight line segment (e.g., a connecting line segment). In some embodiments, upon determining that the current iteration and a particular previous iteration constitute a straight line segment, the computing system may selectively qualify the current iteration based on whether a connecting segment between the previous iteration and the current iteration is sufficiently parallel to or collinear with the connecting line of the current iteration and/or the previous iteration.

In some embodiments, the computing system may characterize and/or qualify the current iteration and/or a particular previous iteration by determining whether the current iteration and the particular previous iteration correspond to a same lane boundary. In some embodiments, the computing system may characterize and/or qualify the current iteration based on a distance and/or time filter. A distance filter may include a spatial criteria of whether a distance from the current iteration to a nearest previous qualified iteration is within a distance range. A time filter may include a temporal criteria of whether a time difference between the recording of the current iteration and the recording of the nearest previous qualified iteration is within a temporal range. For example, the computing system may qualify the current iteration if its distance from the nearest previous qualified iteration is within a certain distance range and disqualify and discard the current iteration if its distance from the nearest previous qualified iteration is outside of the distance range. Nonlimiting examples of the distance range may include a range from 5 meters to 500 meters, a range from 10 meters to 100 meters, a range of 10 meters to 50 meters, and/or any distance range between any of the aforementioned distances. This ensures that the current iteration is not too close to or too far from any previous qualified iteration.

As previously alluded to, for each current or previous iteration, the computing system may obtain or estimate a localization result, which includes a pose of the ego vehicle. The poses may result from a localization operation that includes a translation between the ego vehicle and an origin, and an orientation difference between the ego vehicle and the origin. In some embodiments, the origin may include an artifact with coordinates defined by a global coordinate system. In some embodiments, the localization operation may include a projection between a vehicle coordinate system of the ego vehicle and a global coordinate system. The estimated poses may be determined based on certain ego vehicle-related parameters such as an assumed spatial relationship between the vehicle chassis and body. However, as previously alluded to, the ego vehicle-related parameters may be changing and/or inaccurate, leading to potential errors in the estimated poses.

In some embodiments, upon qualifying the current iteration and/or one or more previous iterations, the computing system may generate a lane representation that includes the respective connecting lines for the current iteration and/or the one or more previous iterations. The computing system may project the generated lane representations to a different space, such as a world coordinate system or global coordinate system. Projecting the generated lane representations to a different space may include applying the pose of an iteration to the generated lane representation of that corresponding iteration.

From a pair of generated and projected lane representations, the computing system may determine a rotation angle of one of the lane representations which satisfies one or more constraints and/or functions. In some embodiments, the pair of generated lane representations includes a current lane representation corresponding to a qualified current iteration and a previous lane representation corresponding to a qualified previous iteration. The determined rotation angle may be used to resolve the predicted heading of the ego vehicle. In some embodiments, the computing system may determine a rotation angle from more than a single pair of generated and projected lane representations.

In some embodiments, a computing system comprises one or more processors; and a memory storing instructions that, when executed by the one or more processors, cause the system to perform operations. The operations include obtaining, from one or more sensors, different iterations of lane indicia data, wherein each iteration of the lane indicia data comprises lane indicia indicative of a presence of a lane; obtaining, from a different computing module, localization results, each localization result comprising a pose of an ego vehicle corresponding to each of the different iterations; characterizing the different iterations of the lane indicia data; selectively qualifying the different iterations of the lane indicia data based on the characterization of the different iterations; for each qualified iteration: generating a lane representation based on the lane indicia data; projecting the lane representation into a different coordinate system and projecting the localization result into the different coordinate system; and for a pair of qualified iterations comprising a first qualified iteration and a second qualified iteration, iteratively determining, based on a function, a rotation angle of a first lane representation corresponding to the first qualified iteration with respect to a second lane representation corresponding to the second qualified iteration; outputting a result of the rotation angle based on the function; and resolving the localization result based on the result of the rotation. In some embodiments, the operations further comprise implementing a navigation and/or planning action of the ego vehicle based on the resolved localization result. In some embodiments, the operations further comprise physically and/or electronically actuating one or more actuators or physical components within the ego vehicle, such as a brake or accelerator pedal, and/or a steering wheel.

In some embodiments, the characterizing of the different iterations comprises, for a particular iteration, determining whether the lane indicia corresponding to the particular iteration constitutes a sufficiently straight line segment or whether the lane indicia is fittable to a straight line segment.

In some embodiments, the selectively qualifying the different iterations comprises: in response to determining that the lane indicia corresponding to the particular iteration constitutes a sufficiently straight line segment or whether the lane indicia is fittable to a straight line segment, qualifying the particular iteration; and in response to determining that the lane indicia corresponding to the particular iteration fails to constitute a sufficiently straight line segment or that the lane indicia is unfittable to a straight line segment, disqualifying the particular iteration.

In some embodiments, the qualifying of the different iterations is based on implementing of a distance filter, the implementing of the distance filter comprising: if a distance between a most recent iteration and a closest previous qualified iteration is within a threshold range of distances, qualifying the most recent iteration; and if a distance between the most recent iteration and the closest previous qualified iteration is outside of the threshold range, disqualifying the most recent iteration.

In some embodiments, generating of the lane representation comprises generating a connecting lane segment that connects the lane indicia.

In some embodiments, the different iterations of lane indicia data are captured with respect to a sensor coordinate system; and the different coordinate system comprises a world coordinate system.

In some embodiments, the pose comprises a first ego vehicle location corresponding to the first qualified iteration and a second ego vehicle location corresponding to the second qualified iteration; the function comprises a difference between a first distance and a second distance; the first distance comprises a distance between the second ego vehicle location and a resulting rotated first lane representation when the first lane representation is rotated by the rotation angle; the second distance comprises a distance between the second ego vehicle location and the second lane representation; and iteratively determining the rotation angle comprises determining the rotation angle that minimizes the function.

In some embodiments, the first distance comprises a distance between the second ego vehicle location and a first particular point (or first particular position) within the resulting rotated first lane representation, wherein the first particular point is selected, such that, a distance between the second ego vehicle location and the first particular point is smaller than a distance between the second ego vehicle location and any other point within the resulting rotated first lane representation; and the second distance comprises a distance between the second ego vehicle location and a second particular point (or second particular position) within the second lane representation, wherein the second particular point is selected, such that, a distance between the second ego vehicle location and the second particular point is smaller than a distance between the second ego vehicle location and any other point within the second lane representation.

In some embodiments, a segment connecting the second ego vehicle location to the second particular point is orthogonal to the estimated pose of the ego vehicle at the second ego vehicle location.

In some embodiments, the first qualified iteration corresponds to a most recent iteration and the second qualified iteration corresponds to a previous iteration.

In some embodiments, an ego vehicle, as illustrated and described, for example, in FIGS. 14-15, may be implemented in conjunction with the computing system described above.

In some embodiments, a method of a computing system performs obtaining, from one or more sensors, different iterations of lane indicia data, wherein each iteration of the lane indicia data comprises lane indicia indicative of a presence of a lane; obtaining, from a different computing module, a localization result comprising a pose of an ego vehicle corresponding to each of the different iterations; characterizing the different iterations of the lane indicia data; selectively qualifying the different iterations of the lane indicia data based on the characterization of the different iterations; for each qualified iteration: generating a lane representation based on the lane indicia data; projecting the lane representation into a different coordinate system and projecting the localization result into the different coordinate system; and for a pair of qualified iterations comprising a first qualified iteration and a second qualified iteration, iteratively determining, based on a function, a rotation angle of a first lane representation corresponding to the first qualified iteration with respect to a second lane representation corresponding to the second qualified iteration; outputting a result of the rotation angle based on the function; and resolving the localization result based on the result of the rotation.

These and other features of the apparatuses, systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the invention are utilized, and the accompanying drawings of which:

FIG. 1 is a diagram that illustrates an example implementation of a computing system that resolves a heading of an ego vehicle.

FIG. 2 is a diagram that illustrates an example implementation of the computing system that resolves a heading of an ego vehicle in more detail.

FIG. 3 is a diagram that illustrates an example vehicle system context related to resolving a heading of an ego vehicle, as well as other functions associated with an ego vehicle computing system.

FIG. 4 is a diagram illustrating example implementations of an iteration characterizing engine and an iteration qualifying engine, which characterize and qualify lane indicia data and/or iterations corresponding to the lane indicia data.

FIG. 5 is a diagram illustrating example implementations of a lane representation generating engine which generate a lane representation corresponding to qualified lane indicia.

FIGS. 6-7 are diagrams illustrating example implementations of a lane representation projecting engine which projects a lane representation into a different coordinate system.

FIGS. 8 and 9A-9D are diagrams illustrating example implementations of a lane representation rotating engine which determines a rotation angle that is indicative of a heading error in an estimated pose or heading of the ego vehicle.

FIG. 10 illustrates an example implementation of a heading resolving engine which resolves a heading of the ego vehicle according to the determined rotation angle.

FIG. 11 illustrates an example implementation of storing and/or retaining iteration data corresponding to different iterations, such as a current iteration and a previous iteration.

FIG. 12 illustrates an example representation of a neural network component which may be used to obtain or predict lane indicia.

FIG. 13 illustrates example implementations of downstream actions following the resolving of an ego vehicle heading.

FIGS. 14-15 illustrate example ego vehicles in which the aforementioned implementations may be implemented.

FIG. 16 illustrates a block diagram of a computer system upon which any of the embodiments described herein may be implemented.

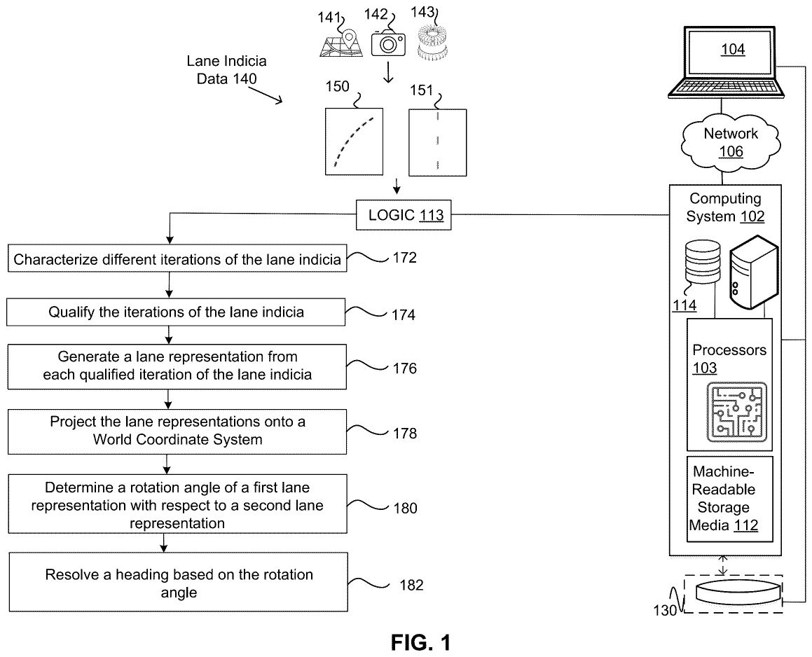

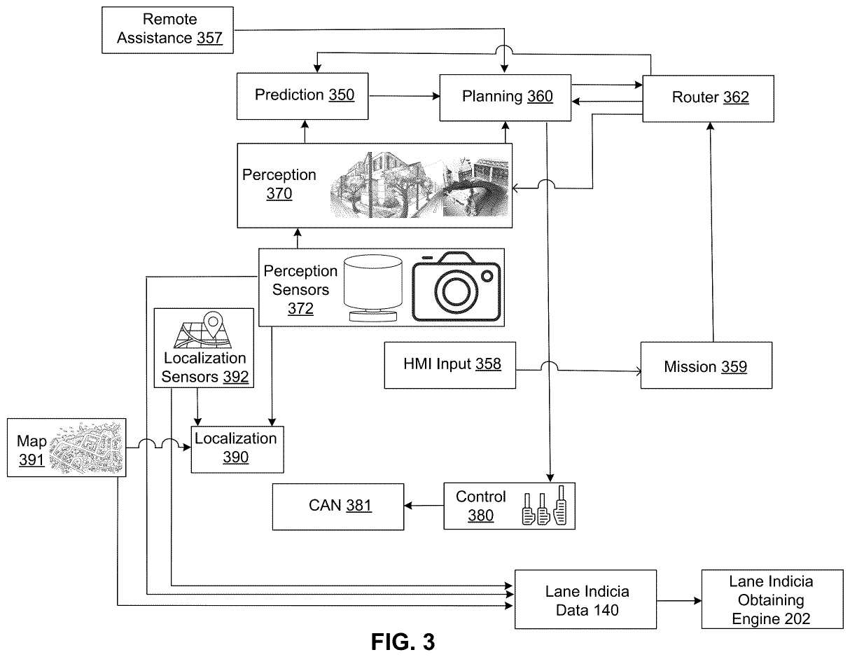

Principles from different figures may apply to, and/or be combined with other figures as suitable. For example, the principles illustrated in FIGS. 1 and/or 2 may be applied to and/or combined with principles from any of FIGS. 3-8, 9A-9D, and 10-13, and vice versa.

### DETAILED DESCRIPTION

A computing system associated with an ego vehicle resolves vehicle heading or orientation (hereinafter “heading”). A heading may refer to a direction that the ego vehicle is facing. The facing direction may include a direction with respect to a yaw component (e.g., with respect to true north). In some embodiments, an ego vehicle may refer to an autonomous vehicle, a semi-autonomous vehicle, or any other type of vehicle.

An existing technical problem includes an inability to accurately and efficiently determine, confirm, and/or resolve (hereinafter “resolve”) a heading of an ego vehicle, especially when certain ego vehicle-related parameters of an ego vehicle change, are inaccurate, and/or are uncalibrated. This inability may detrimentally increase a probability of a disengagement or accident during navigation.

In some embodiments, an uncalibrated parameter may refer to an actual measurement of a parameter deviating from a previously calibrated measurement of the parameter. In some embodiments, an inaccurate parameter may include inaccurate measurements of an extrinsic. In some embodiments, the extrinsic may refer to a pose difference, which may include a difference in position (e.g., distance) and/or orientation (e.g., angle) in any of three dimensions between a rear axle of the ego vehicle and a center of an inertial measurement unit (IMU). A rear axle is part of, or connected with, a chassis, while the IMU is mounted within the body. The chassis and the body are connected by suspension springs. Inaccuracy of the extrinsic may be attributed to displacement of the body relative to the chassis. Causes of this displacement may include vibration of the ego vehicle, changes in occupants within a cabin of the ego vehicle, maintenance, and/or other changes in weight and/or force distribution within the ego vehicle.

Embodiments of the present invention overcome these aforementioned bottlenecks. The computing system resolves vehicle heading even when certain vehicle-related parameters are changing, inaccurate and/or uncalibrated. The computing system resolves vehicle heading using a Global Navigation Satellite System (GNSS), Real-Time Kinematic (RTK), and lane detection. In some embodiments, lane detection may include detection of lane indicia which indicate or are likely to indicate lane boundaries or lane lines (hereinafter “lane boundaries”) or portions thereof. In some embodiments, being likely to indicate may refer to a lane indicia exceeding a threshold probability of being or indicating lane boundaries. As nonlimiting examples, lane boundaries may refer to markings including solid white lines separating traffic traveling in a same direction, yellow lines separating traffic traveling in different directions, broken lines which are crossable, edge lines that separate a road from a shoulder, or portions thereof. In some embodiments, lane indicia may include points, each of which may correspond to different spatial coordinates. The spatial coordinates may be defined within a sensor coordinate system of a sensor that detected the lane indicia.

Although the foregoing focuses on lane detection, the disclosure is not intended to be limited to such. For example, detection of other indicia may be used in place of, or in addition to, lane detection. Other indicia may include any features of a geometry of a road, including physical barriers such as center dividers, curbs, railings, and/or other barriers, and/or other stationary objects on a road.

In some embodiments, the computing system may periodically and/or iteratively resolve a heading of the ego vehicle while the ego vehicle is in motion. In some embodiments, a frequency and/or time periods at which the heading is resolved may be same as or different from a frequency and/or time periods at which the perception sensors detect lane indicia. In some embodiments, the computing system may resolve a heading at certain fixed time intervals. In some embodiments, the computing system may adjust a frequency and/or time periods at which the heading is resolved based on environmental conditions such as weather, visibility, traffic conditions such as a density of traffic, a location, or a road geometry through which the ego vehicle is traversing. For example, if weather conditions are rainy, visibility is limited, density of traffic is high (e.g., outside of respective thresholds), and/or if a road geometry includes a high density of curves, then the computing system may resolve the heading at higher frequencies.

In some embodiments, one or more perception sensors associated with the computing system periodically and/or iteratively detect lane indicia. At each iteration, or time instance, the perception sensors may obtain one or more records or frames that contain lane indicia indicate of, or have at least a threshold probability of indicating, lane indicia. In some embodiments, as previously mentioned, lane indicia may include indicators of a lane such as portions of a lane boundary. In some embodiments, within a single record, each instance of lane indicia may correspond to one or more three-dimensional (3-D) coordinates, or have coordinates up to three dimensions, and/or may be detected relative to a sensor coordinate system. The sensor coordinate system may be relative to a rear axle of the ego vehicle. In some embodiments, at each iteration, the computing system may also obtain a localization result including a pose of the ego vehicle. In some embodiments, the computing system may obtain the localization result from a different computing module.

The computing system may obtain a most recent iteration or current iteration (hereinafter “current iteration”) of detected lane indicia according to timestamps which indicate a time of detection. Such detected lane indicia corresponding to the current iteration may be referred to as current lane indicia. The computing system may obtain or retrieve one or more previous iterations prior to the current iteration. The computing system may characterize and/or qualify or validate (hereinafter “qualify”) the current iteration. In some embodiments, qualifying may refer to confirming a qualified status of the current iteration. In some embodiments, characterizing may include determining whether the current lane indicia constitute a sufficiently straight line when connected, and/or are sufficiently fittable to a connecting line. The computing system may selectively qualify and/or retain the current iteration based on whether the current iteration constitutes a sufficiently straight segment. The computing system may retain the current iteration if the current iteration is deemed to be qualified, or in other words, if the current iteration constitutes a straight segment. Otherwise, the computing system may discard or disregard the current iteration.

In some embodiments, previous iterations may already have been characterized and/or qualified. Alternatively, if previous iterations have not already been characterized and qualified, the computing system may perform an analogous characterization and qualification process with respect to any previous iterations. In some embodiments, the qualification process for previous iterations may include determining, for lane indicia in each previous iteration, whether the lane indicia constitute a sufficiently straight line, and/or are sufficiently fittable to a connecting line. In some embodiments, upon determining that the current iteration and a particular previous iteration constitute a straight line, the computing system may selectively qualify the current iteration based on whether a connecting segment between the previous iteration and the current iteration is sufficiently parallel to or collinear with the connecting line of the current iteration and/or the previous iteration.

In some embodiments, the computing system may characterize and/or qualify the current iteration and/or a particular previous iteration by determining whether the current iteration and the particular previous iteration correspond to a same lane boundary. In some embodiments, the computing system may characterize and/or qualify the current iteration based on a distance and/or time filter. A distance filter may include a spatial criteria of whether a distance from the current iteration to a nearest previous qualified iteration is within a distance range. A time filter may include a temporal criteria of whether a time difference between the recording of the current iteration and the recording of the nearest previous qualified iteration is within a temporal range. For example, the computing system may qualify the current iteration if its distance from the nearest previous qualified iteration is within a certain distance range and disqualify and discard the current iteration if its distance from the nearest previous qualified iteration is outside of the distance range. Nonlimiting examples of the distance range may include a range from 5 meters to 500 meters, a range from 10 meters to 100 meters, a range of 10 meters to 50 meters, and/or any distance range between any of the aforementioned distances. This ensures that the current iteration is not too close to or too far from any previous qualified iteration.

As previously alluded to, for each current or previous iteration, the computing system may obtain or estimate a localization result, which includes a pose of the ego vehicle. The pose may result from a localization operation that includes a translation between the ego vehicle and an origin, and an orientation difference between the ego vehicle and the origin. In some embodiments, the origin may include an artifact with coordinates defined by a global coordinate system. In some embodiments, the localization operation may include a projection between a vehicle coordinate system of the ego vehicle and a global coordinate system. The estimated pose may be determined based on certain ego vehicle-related parameters such as an assumed spatial relationship between the vehicle chassis and body. However, as previously alluded to, the ego vehicle-related parameters may be changing and/or inaccurate, leading to potential errors in the estimated pose.

In some embodiments, upon qualifying the current iteration and/or one or more previous iterations, the computing system may generate a lane representation that includes the respective connecting lines for the current iteration and/or the one or more previous iterations. The computing system may project the generated lane representations to a different space, such as a world coordinate system or global coordinate system. Projecting the generated lane representations to a different space may include applying the pose of an iteration to the generated lane representation of that corresponding iteration.

From a pair of generated and projected lane representations, the computing system may determine a rotation angle of one of the lane representations which satisfies one or more constraints and/or functions. In some embodiments, the pair of generated lane representations includes a current lane representation corresponding to a qualified current iteration and a previous lane representation corresponding to a qualified previous iteration. The determined rotation angle may be used to resolve the predicted heading of the ego vehicle. In some embodiments, the computing system may determine a rotation angle from more than a single pair of generated and projected lane representations. These concepts summarized above are illustrated in further detail in the FIGS.

FIG. 1 is a diagram that illustrates an example implementation of a computing system 102, which may be associated with an ego vehicle. The computing system 102 resolves a localization result, such as a heading, of the ego vehicle, in order to compensate for changes and/or inaccuracies in certain ego-vehicle parameters which result in inaccurate heading determination or estimation. The ego vehicle may include a vehicle (e.g., an AV) that is making locomotive decisions and executing the locomotive decisions while responding to different stimuli. The computing system 102 resolves the localization result in real-time or near real-time, as the ego vehicle is moving.

The computing system 102 obtains lane indicia data 140 from one or more sensors of different modalities, including location sensors such as GPS 141, cameras 142, and Lidars 143. Other sensors may include radars. The lane indicia data 140 may include media data, such as images and/or videos, and/or data of different formats. The lane indicia data 140 may include different iterations, each of which may correspond to different frames and/or times of capture. The lane indicia data 140 may be measured with respect to a sensor coordinate frame. Lane indicia data may indicate or may have at least a threshold probability of containing lane indicia, which may include points or other portions of lane boundaries. For each iteration, the computing system 102 obtains a localization result that includes a pose (e.g., location and orientation) of the ego vehicle. The localization result may be obtained from a different computing module, which may be separate from the computing system 102, for example. Lane indicia data, in some embodiments, may include curved lane indicia data 150 indicative of a curved lane and/or straight lane indicia data 151 indicative of a straight lane.

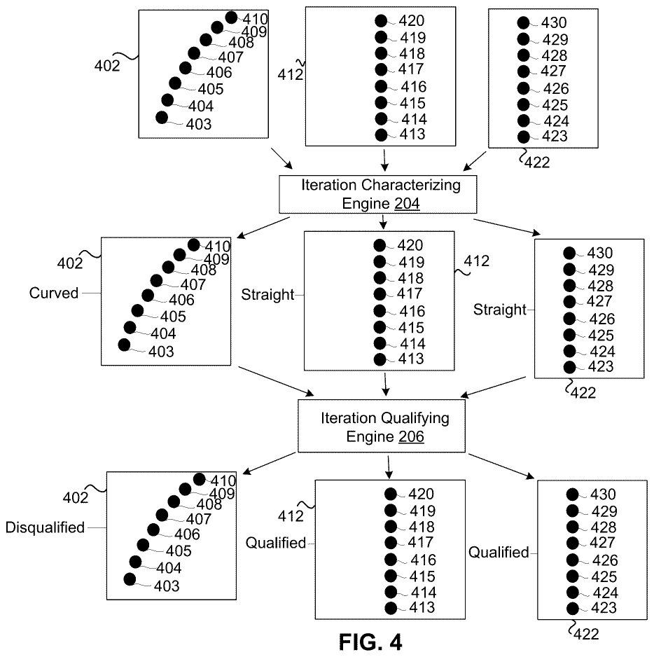

After obtaining the lane indicia data 140, the computing system 102, in step 172, characterizes one or more different iterations of the lane indicia, as illustrated, for example, in FIG. 4. In some embodiments, characterizing may include, for each separate iteration, determining whether the iteration constitutes a straight line segment or a curved segment. In some embodiments, a current iteration may not have been characterized while previous iterations may have already been characterized. Alternatively, the computing system 102 may also characterize the previous iterations. In some embodiments, the computing system 102 may selectively remove certain outliers of the lane indicia prior to characterizing.

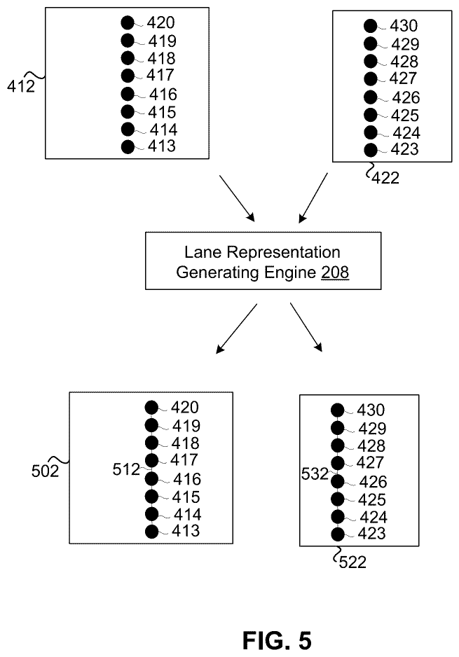

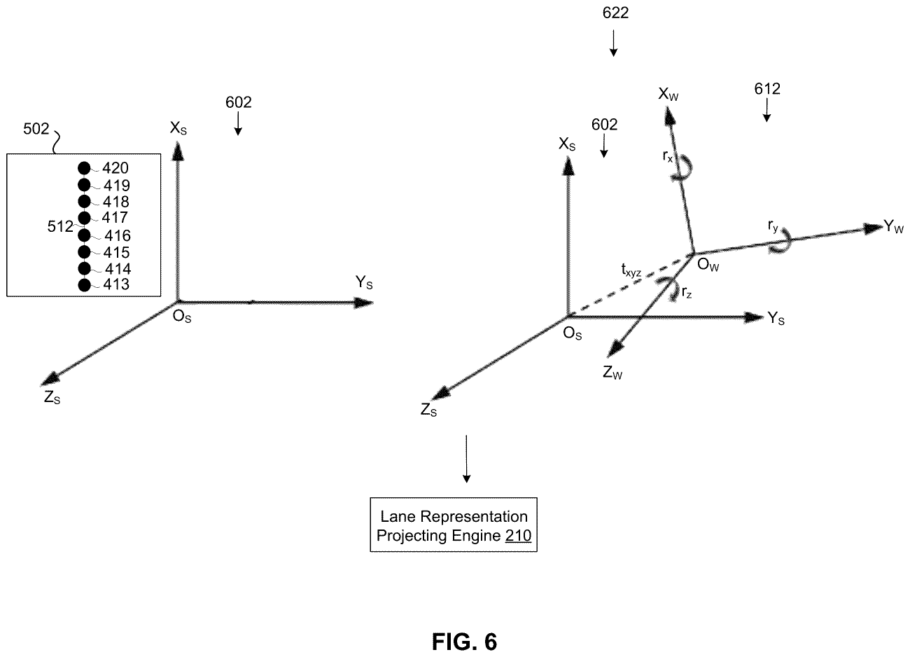

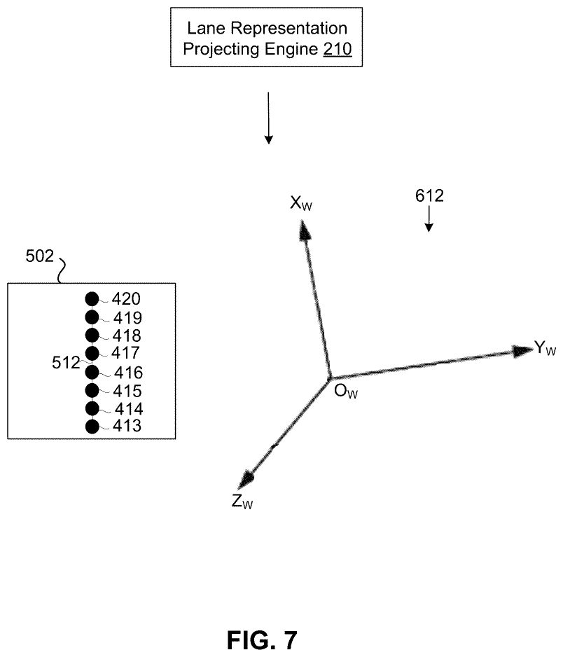

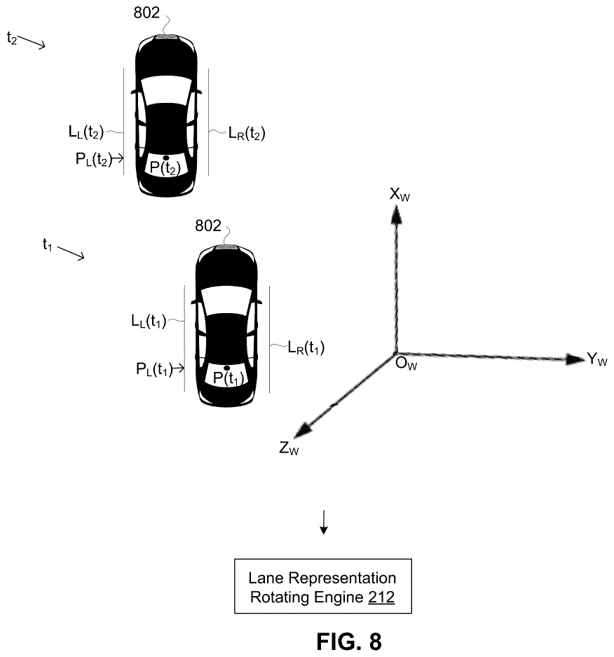

In step 174, the computing system 102 selectively qualifies each iteration based at least in part on the characterization of that iteration, as illustrated, for example, in FIG. 4. The computing system 102 may additionally qualify each iteration based on a temporal distance, a spatial distance and/or a relative coordinate difference between that iteration and a preceding iteration. In step 176, the computing system 102 may, for each qualified iteration, generate a lane representation, as illustrated, for example, in FIG. 5. In some embodiments, a lane representation includes a connecting line segment that links the lane indicia. In step 178, as illustrated, for example, in FIGS. 6 and 7, the computing system 102 may convert or project (hereinafter “project”) the lane representation and/or the localization result into a different coordinate system. The different coordinate system may include a world coordinate system. In step 180, given a pair of qualified iterations, including a first qualified iteration and a second qualified iteration, the computing system 102 may determine, based on a function, a rotation angle of a first lane representation corresponding to the first qualified iteration with respect to a second lane representation corresponding to the second qualified iteration. Certain details of step 180 are further illustrated in FIGS. 8, 9A-9D, and 10. In some embodiments, the first lane representation may correspond to a current iteration while the second lane representation may correspond to a previous iteration. The rotation angle may be indicative of a heading error of the ego vehicle. In step 182, the computing system 102 may resolve the localization result based on the rotation angle.

The computing system 102 may perform, control, and/or coordinate maneuvering and navigation of the ego vehicle following the resolving of the localization result. For example, the computing system 102 may generate and transmit one or more executable commands directed to one or more ego vehicle components such as a brake, an actuator, or a steering wheel. The executable commands, when implemented, may include, for example, limiting a force applied to an actuator, or limiting an extent to which a steering wheel turns.

The implementation in FIG. 1 can include at least one computing device 104 which may be operated by an entity such as a user, and may include or be part of a human machine interface (HMI). The computing device 104 may receive any outputs from the computing system 102 via a network 106, visually render any outputs received, and/or provide inputs or feedback to the computing system 102. In general, the computing device 104 can interact with a database 130 directly or over a network 106, for example, through one or more graphical user interfaces, application programming interfaces (APIs), and/or webhooks running on the computing device 104. The computing device 104 may include one or more processors and memory.

The computing system 102 may include one or more processors 103 which may be configured to perform various operations by interpreting machine-readable instructions, for example, from a machine-readable storage media 112. In some examples, the one or more processors 103 may be combined or integrated into a single processor, and some or all functions performed by one or more of the processors 103 may not be spatially separated, but instead may be performed by a common processor. The one or more processors 103 may be physical or virtual entities. For example, as physical entities, the one or more processors 103 may include one or more processing circuits, each of which can include one or more processing cores. Additionally or alternatively, for example, as virtual entities, the one or more processors 103 may be encompassed within, or manifested as, a program within a cloud environment. The computing system 102 may also include a storage 114, which may include a cache for faster access compared to the database 130.

The one or more processors 103 may further be connected to, include, or be embedded with logic 113 which, for example, may include, store, and/or encapsulate instructions that are executed to carry out the functions of the one or more processors 103. In general, the logic 113 may be implemented, in whole or in part, as software that is capable of running on the computing system 102, and may be read or executed from the machine-readable storage media 112. The logic 113 may include, as nonlimiting examples, expressions, functions, arguments, evaluations, and/or code. Here, in some examples, the logic 113 encompasses functions of or related to obtaining lane indicia data, characterizing different iterations of the lane indicia data, qualifying the different iterations of the lane indicia data, generating a lane representation for each qualified iteration, projecting the generated lane representation onto a world coordinate system, determining, according to a function, a rotation angle of a first lane representation with respect to a second lane representation, and resolving a heading of the ego vehicle based on the rotation angle. Functions or operations described with respect to the logic 113 may be associated with a single processor or multiple processors.

The database 130 may include, or be configured to obtain or store, the lane indicia data 140, characterized lane indicia data, qualified lane indicia data, generated lane representations, projected lane representations, rotation angles, resolved headings, and/or localization results of the ego vehicle, and/or any associated intermediate outputs.

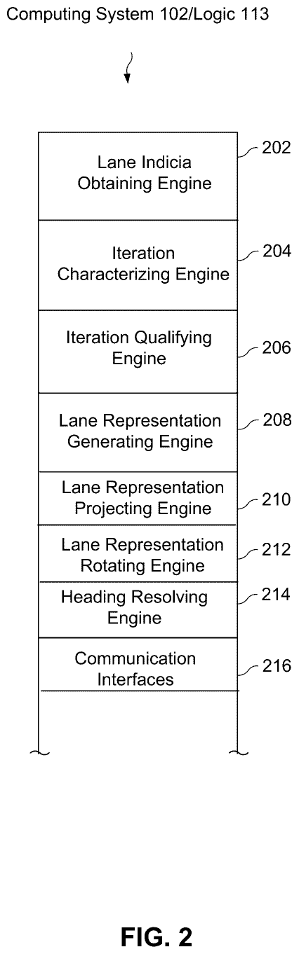

FIG. 2 is a block diagram that depicts an example implementation of the computing system 102 and/or the logic 113, in accordance with some embodiments. The computing system 102 contains hardware, software and/or firmware capable of communicating with any of the aforementioned sensors and other sensors (e.g., GPS 141, cameras 142, Lidars 143, radars, sonars, ultrasonic sensors, IMUs, accelerometers, gyroscopes, magnetometers, and FIRs) in FIG. 1 and/or the computing device 104. The computing system 102 may communicate with the computing device 104 and/or the sensors via application programming interfaces (APIs). The computing system 102 includes a lane indicia obtaining engine 202, an iteration characterizing engine 204, an iteration qualifying engine 206, a lane representation generating engine 208, a lane representation projecting engine 210, a lane representation rotating engine 212, a heading resolving engine 214, and/or one or more communication interfaces 216. FIG. 2 describes exemplary operations of the computing system 102 consistent with FIG. 1.

The lane indicia obtaining engine 202 is configured to obtain the lane indicia data 140 from one or more sensors such as cameras. The iteration characterizing engine 204 is configured to characterize each iteration of the obtained lane indicia data. In some embodiments, the characterizing may include determining whether the lane indicia in each iteration constitutes, or is sufficiently fittable to, a line segment. In some embodiments, the characterizing is based on a linear regression or a least squares regression of the lane indicia, and may be based on a R-squared value and/or a sum of squared errors or deviations between the individual lane indicia and a fitted line segment for the individual lane indicia. In some embodiments, the iteration characterizing engine 204 may characterize other characteristics of each iteration, assuming that the each iteration being characterized and a nearest previous iteration has been determined to constitute a line segment. For example, the iteration characterizing engine 204 may determine a spatial and/or temporal distance and/or a difference in relative spatial coordinates between each iteration and a nearest previous iteration that constitutes a line segment. In some embodiments, the iteration characterizing engine 204 may determine whether each iteration and a nearest previous iteration correspond to a same lane boundary. Such a determination may be based, for example, on whether the fitted line segments corresponding to each iteration and a nearest previous iteration are parallel or collinear. One aspect of an example implementation of the iteration characterizing engine 204 is illustrated in FIG. 4.

The iteration qualifying engine 206 is configured to selectively qualify each iteration based on its characterization. In some embodiments, the iteration qualifying engine 206 may determine that an iteration is qualified if that iteration constitutes, or is sufficiently fittable to, a line segment as opposed to a curved segment. In some embodiments, being fittable to a line segment may refer to a R-squared value above a threshold value (e.g., greater than 0.8, 0.9, 0.95, or 0.99) and/or a sum of squared errors being below a threshold error. In some embodiments, the iteration qualifying engine 206 may determine that an iteration is disqualified, or unqualified, if that iteration constitutes a curved or other nonlinear segment, or is unfittable to a line segment. An example implementation of the iteration qualifying engine 206 is illustrated in FIG. 4.

Additionally, the iteration qualifying engine 206 may qualify each iteration based on a spatial and/or temporal distance and/or a difference in relative spatial coordinates between each iteration and a nearest previous iteration, assuming that the each iteration and the nearest previous iteration constitute line segments. In some embodiments, if a spatial distance between a given iteration and a nearest previous iteration is within a given distance range, the iteration qualifying engine 206 may determine that the given iteration is qualified. In some embodiments, if a spatial distance between the given iteration and the nearest previous iteration is outside of the given distance range, the iteration qualifying engine 206 may determine that the given iteration is disqualified or unqualified. In some embodiments, the iteration qualifying engine 206 may qualify a given iteration if the given iteration is determined to belong to a common lane boundary as a nearest previous iteration. The iteration qualifying engine 206 may make such a determination if the line segment constituting the given iteration satisfies at least a threshold level of collinearity with the nearest previous iteration.

The lane representation generating engine 208 is configured to generate, for a qualified iteration, a lane representation that includes a connecting segment fitted for the lane indicia in the qualified iteration. An example implementation of the lane representation generating engine 208 is illustrated in FIG. 5. The lane representation projecting engine 210 is configured to project a generated lane representation onto a different coordinate system, such as a world coordinate system. An example implementation of the lane representation projecting engine 210 is illustrated in FIGS. 6 and 7.

The lane representation rotating engine 212 is configured to determine a rotation angle for a given lane representation. In some embodiments, the determining of the rotation angle may also be an iterative process, distinct from the iterations of lane indicia. Given a pair of qualified iterations, including a first qualified iteration and a second qualified iteration, the lane representation rotating engine 212 may determine, based on a function, a rotation angle of a first lane representation with respect to a second lane representation. The first lane representation may correspond to the first qualified iteration and the second lane representation may correspond to the second qualified iteration. In some embodiments, the first qualified iteration may correspond to a current iteration while the second qualified iteration may correspond to a previous iteration (e.g., a most recent previous iteration prior to the current iteration). In some embodiments, the lane representation rotating engine 212 may determine the rotation angle using one or more nonlinear functions and an optimizer such as ceres or a similar framework.

In some embodiments, the lane representation rotating engine 212 may be configured to determine the rotation angle based on a first ego vehicle location corresponding to the first qualified iteration and/or a second ego vehicle location corresponding to the second qualified iteration. The first ego vehicle location may be a location of the ego vehicle at the time the first qualified iteration was captured. The second ego vehicle location may be a location of the ego vehicle at the time the second qualified iteration was captured.

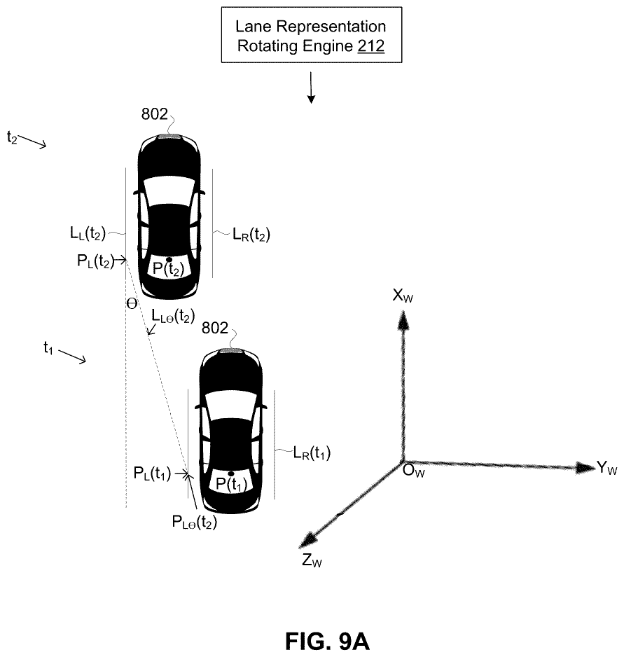

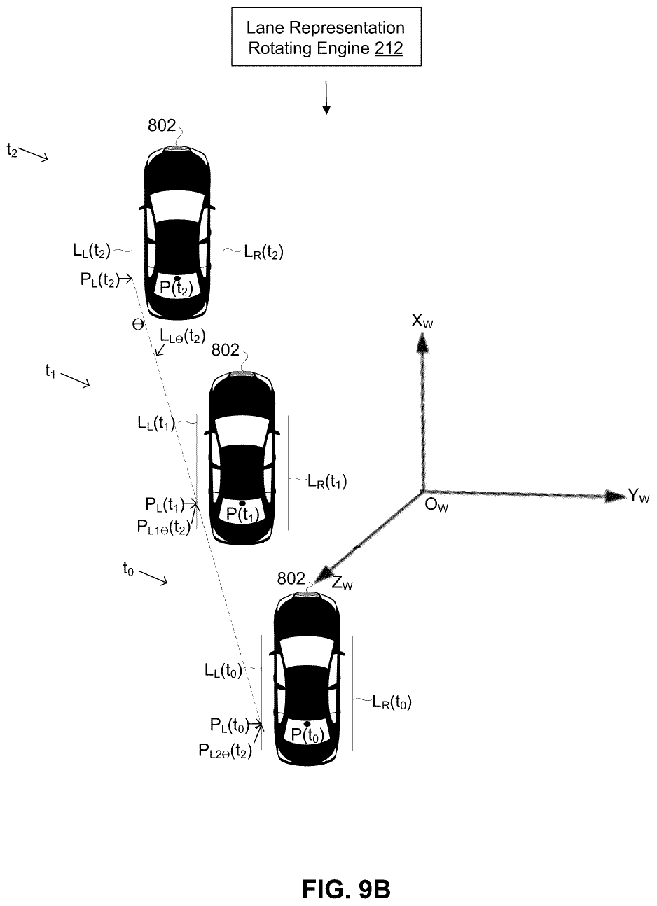

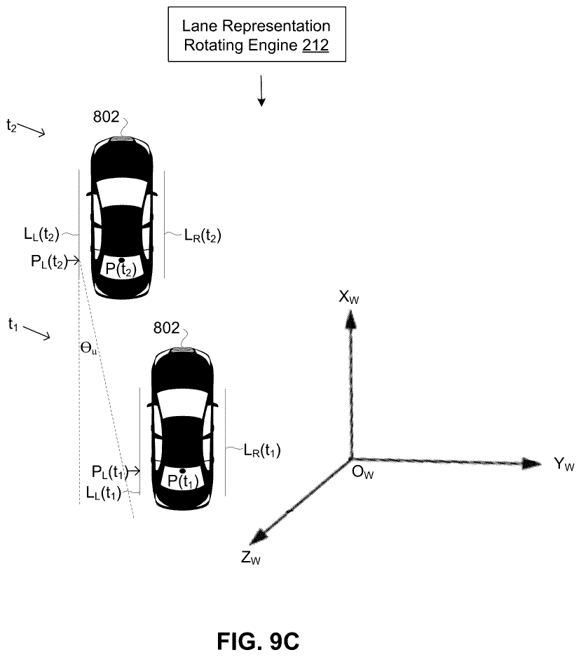

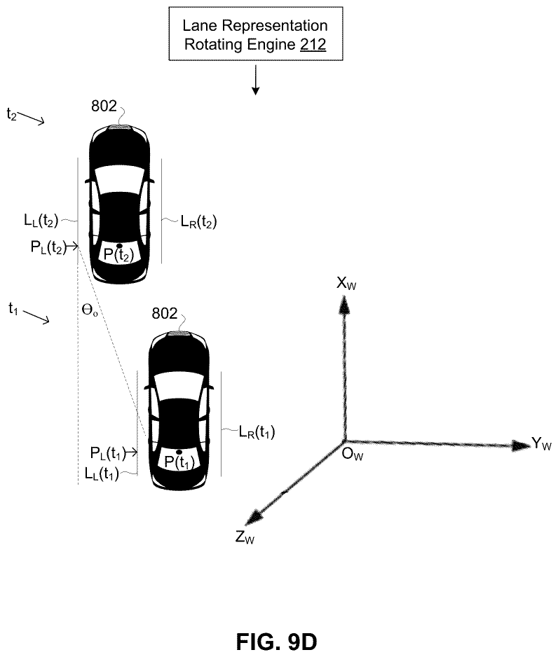

In some embodiments, the function may include a difference between a first distance and a second distance. The first distance includes a distance between the second ego vehicle location and a resulting rotated first lane representation when the first lane representation is rotated by the rotation angle. The second distance includes a distance between the second ego vehicle location and the second lane representation. In some embodiments, the first distance includes a distance between the second ego vehicle location and a first particular point within the resulting rotated first lane representation. In some embodiments, the first particular point is selected, such that, a distance between the second ego vehicle location and the particular point is smaller than a distance between the second ego vehicle location and any other point within the resulting rotated first lane representation. In some embodiments, the second distance includes a distance between the second ego vehicle location and a second particular point within the second lane representation. The second particular point is selected, such that, a distance between the second ego vehicle location and the second particular point is smaller than a distance between the second ego vehicle location and any other point within the second lane representation. In some embodiments, the rotation angle may be determined as a rotation angle that minimizes the difference between the first distance and the second distance. An example implementation of the lane representation rotating engine 212 in a scenario with two iterations is illustrated in FIG. 9A.

The above description regarding the lane representation rotating engine 212 assumes two iterations. In some embodiments, the lane representation rotating engine 212 may determine the rotation angle based on more than two iterations, as further illustrated in FIG. 9D. In this scenario, one or more third qualified iterations may be captured when the ego vehicle is at one or more third ego vehicle locations. The function may be expanded to include a summation of the aforementioned first difference and one or more second differences. The first difference is between a first distance and a second distance, and the one or more second differences are between the first distance and one or more third distances. The one or more third distances include respective distances between the second ego vehicle location and one or more third lane representations. The one or more third lane representations correspond to the one or more third qualified iterations. The rotation angle may be determined as a rotation angle that minimizes the summation of the aforementioned first difference and one or more second differences.

The heading resolving engine 214 may resolve a determined pose, previously determined by a localization result, of the ego vehicle, based on the rotation angle. For example, the heading resolving engine 214 may adjust the determined pose by the rotation angle.

The communication interfaces 216 may include APIs and be configured to communicate between the computing system 102, the ego vehicle, and any other external sources. For example, the communication interfaces 216 may be configured to communicate with one or more sensors to obtain the lane indicia data 140, and communicate with the physical ego vehicle components in order to maneuver the ego vehicle.

FIG. 3 illustrates an example implementation of the computing system 102 that obtains the lane indicia data 140, in context with other components of the ego vehicle, which may be part of the computing system 102 or separate from the computing system 102. The other components may provide navigational related (herein “navigational”) data to the computing system 102 or obtain navigational data as part of the computing system 102. In some embodiments, FIG. 3 provides a similar perspective as FIG. 1 and FIG. 2 and may be implemented in conjunction with FIG. 1 and FIG. 2. The navigational data may include raw and/or processed data, and may be manifested in different formats, including textual data, media data, binary data, unstructured data, and/or structured data. The other components may include a prediction source 350, a planning source 360, a perception source 370, a control source 380, a localization source 390, and/or a router 362.

The perception source 370 may be implemented as part of the lane indicia obtaining engine 202, the iteration characterizing engine 204 and/or the iteration qualifying engine 206. To summarize, the perception source 370 may obtain and/or process lane indicia data 140 from perception sensors 372, which may include sensors of different modalities including any of Lidar, camera, radar, ultrasonic, sonar, and/or far infrared (FIR) sensors as mentioned in FIG. 1. The perception sensors 372 may work in conjunction with any localization sensors described. The perception source 370 may combine, merge, or fuse data from different modalities. The perception source 370 may perform entity recognition (e.g., lane indicia recognition), for example, based on semantic segmentation and/or instance segmentation. The perception source 370 may thus recognize lane indicia and attributes thereof, including locations and characteristics of the lane indicia.

The perception source 370 may provide certain outputs such as navigational data to the prediction source 350 and/or the planning source 360. In some embodiments, the prediction source 350 may predict one or more trajectories and/or behaviors of entities that were captured by the perception source 370. The prediction source 350 may feed or provide outputs to the planning source 360.

The planning source 360 may plan one or more actions, such as navigation or locomotive actions which may encompass planning a route based on the outputs from the perception source 370 and/or the prediction source 350, and/or planning actuation-related actions such as changing lanes, braking, and/or accelerating, or controlling modes such as cruise control (e.g., adaptive cruise control, intelligent cruise control). The planning source 360 may obtain outputs of a remote assistance source 357 which may be external to the ego vehicle. For example, the planning source 360 may obtain indications of remote operations such as tele assistance or teleoperations, and accordingly modify plans. The control source 380 may receive outputs from the planning source 360. The control source 380 may implement any of, or a subset (e.g., a portion) or all of the actions planned by the planning source 360.

The localization source 390 may obtain information from localization sensors 392, from the perception sensors 372, and/or geospatial information such as a map 391. In some embodiments, at least a portion of, or an entirety of, the geospatial information may be unavailable. The localization sensors 392 may include global navigation satellite system (GNSS) sensors, inertial measurement unit (IMU), accelerometers, gyroscopes, and magnetometers, which may identify a current location of the ego vehicle. The map 391 may include a standard definition (SD) map. The computing system 102 may, as a sanity check, compare one or more outputs of the perception sensors 372 to any entities, such as static entities, on the map 391. For example, if the map 391 illustrates an entity such as a traffic sign at a particular location but that entity is undetected by the perception sensors 372, the computing system 390 may determine a possible failure, malfunction, and/or lack of calibration of the perception sensors 372. The computing system 102 may either transmit this indication of a potential issue to the perception sensors 372 or to a controller area network (CAN) agent 381.

The control source 380 may be connected to the CAN agent 381, which may be part of or include a CAN bus. In some embodiments, the control source 380 may be implemented as part of the operating engine 214. The CAN agent 381 may communicate with other controllers (e.g., microcontrollers) and devices associated with the ego vehicle, and/or may generate reports pertaining to ego vehicle operations and statuses. The router 362 may provide connection to other external entities and/or may create a vehicle area network (VAN). Meanwhile, an HMI input 358, which may be obtained from the computing device 104, may provide a mission 359 which includes an intended destination.

FIG. 4 is a diagram illustrating implementations of the iteration characterizing engine 204 and the iteration qualifying engine 206. In FIG. 4, the iteration characterizing engine 204 obtains lane indicia data 402, 412, and/or 422, which may be implemented as the lane indicia data 140. In some embodiments, the lane indicia data 402, 412, and/or 422 may correspond to different iterations, captured at different times. The lane indicia data 402 may include lane indicia 403-410, which may include points or portions of a lane boundary. The lane indicia data 412 may include lane indicia 413-420. The lane indicia data 422 may include lane indicia 423-430. The iteration characterizing engine 204 may characterize the lane indicia data 402 as curved, and characterize the lane indicia data 403 and the lane indicia data 422 as straight. In some embodiments, characterization of lane indicia data may be equivalent or analogous to characterization of a corresponding iteration. Thus, characterization, and/or qualification, of lane indicia data and characterization, and/or qualification, of a corresponding iteration may be referred to interchangeably.

The iteration characterizing engine 204 may characterize the lane indicia data 402 as curved because any line segment fitted for the lane indicia 403-410 fails to sufficiently fit the lane indicia 403-410. For any fitted line segment, spatial deviations between at least some of the lane indicia 403-410 and the fitted line segment may be too large. The iteration characterizing engine 204 may characterize the lane indicia data 412 as straight because a line segment connecting the lane indicia 413-420 sufficiently fits the lane indicia 413-420. Similar rationale applies for the lane indicia data 422.

The iteration qualifying engine 206 may identify and/or mark the lane indicia data 402 as disqualified because the lane indicia data 402 fails to constitute a line segment, and is unfittable to any line segment. Meanwhile, the iteration qualifying engine 206 may identify and/or mark the lane indicia data 412 and 422 as qualified or at least partially qualified because the lane indicia data 412 and 422 constitute line segments, which sufficiently fit the lane indicia data 412 and 422. In some embodiments, if the iteration qualifying engine 206 identifies particular lane indicia data or a corresponding iteration as qualified based on whether it constitutes a line segment, then the iteration qualifying engine 206 may at least temporarily retain the particular lane indicia data or the corresponding iteration. Alternatively, the iteration qualifying engine 206 may perform further tests to fully identify whether the particular lane indicia data or the corresponding iteration is fully qualified. These further tests may include spatial and/or temporal filters. For example, the spatial and/or temporal filters may include a criteria of whether the particular lane indicia data is separated by a spatial and/or temporal difference of between two threshold values from a nearest previously qualified iteration. In particular, the iteration qualifying engine 206 may determine whether the particular lane indicia data is at least a minimum spatial distance away from the nearest previously qualified iteration, and at most a maximum spatial distance away from the nearest previously qualified iteration. Additionally, the iteration qualifying engine 206 may determine the particular lane indicia data belongs to a common lane boundary as (e.g., is collinear with) the nearest previously qualified iteration. This determination may be based on a relative spatial coordinate difference between the particular lane indicia data and previous lane indicia data corresponding the nearest previously qualified iteration. This relative spatial coordinate difference may be compared to characteristics of the fitted line corresponding to the particular lane indicia data and/or to the nearest previously qualified iteration. In some embodiments, if the iteration qualifying engine 206 identifies the particular lane indicia data as fully qualified, the iteration qualifying engine 206 may determine to retain, and/or execute commands to retain, the particular lane indicia data at least for a temporary period of time. This temporary period of time may include any suitable period such as 5 seconds, 10 seconds, 20 seconds, 30 seconds, 45 seconds, 1 minute, 5 minutes, 10 minutes, and/or any value therebetween.

FIG. 5 is a diagram illustrating implementations of the lane representation generating engine 208. In FIG. 5, the lane representation generating engine 208 generates a lane representation for any qualified, or fully qualified, lane indicia data. In FIG. 5, assume that the lane indicia data 412 and 422 are each fully qualified (e.g., constitutes a line segment, satisfies spatial and/or temporal thresholds compared to a nearest previous qualified iteration, is collinear with a nearest previous qualified iteration). The lane representation generating engine 208 may generate respective lane representations 502 and 522 corresponding to the lane indicia data 412 and 422. In some embodiments, generating lane representations may encompass generating a connecting segment fitted to the lane indicia data. The connecting segment may include a line segment that best fits the lane indicia data. For example, in FIG. 5, the lane representation generating engine 208 may generate connecting segments 512 and 532 for the lane representations 502 and 532, respectively. In some embodiments, although not shown in FIG. 5, the lane representation generating engine 208 may, after generating a connecting segment, remove at least a portion of, or an entirety of, the lane indicia data. For example, the lane representation generating engine 208 may remove the lane indicia data 413-420 after generating the connecting segment 512. The lane representation generating engine 208 may remove the lane indicia data 423-430 after generating the connecting segment 522.

FIGS. 6-7 are diagrams illustrating implementations of the lane representation projecting engine 208. FIG. 6 illustrates inputs to the lane representation projecting engine 208, in which the generated lane representation 502 is originally represented within a sensor coordinate system 602. FIG. 7 illustrates an output from the lane representation projecting engine 208, in which the generated lane representation 502 has been projected, via rigid body transformation, into a different coordinate system 612, such as a world coordinate system.

In FIG. 6, the lane representation projecting engine 208 obtains the generated lane representation 502 as well as transformation data 622 that includes a spatial relationship between the sensor coordinate system 602 and the different coordinate system 612. The transformation data 622 may include, or indicate, transformation operations to project the generated lane representation 502, originally represented according to the sensor coordinate system 602, to the different coordinate system 612.

In FIG. 6, the sensor coordinate system 602 is illustrated as having an origin O_{S}, and cartesian coordinate axes Xₛ, Yₛ, and Zₛ. The different coordinate system 612 is illustrated as having an origin Ow, and cartesian coordinate axes X_{W}, Y_{W}, and Z_{W}. Transforming from the sensor coordinate system 602 to the different coordinate system 612 may entail a transformation matrix, which represents translation and/or rotation operations. Here, a translation t_{xyz} and rotations rₓ, r_{y}, and r_{z} are required to transform from the sensor coordinate system 602 to the different coordinate system 612. Meanwhile, FIG. 7 illustrates that the lane representation projecting engine 208 has projected the lane representation 502 into the different coordinate system 612.

FIGS. 8 and 9A-9D are diagrams illustrating implementations of the lane representation rotating engine 212. FIG. 8 illustrates example inputs to the lane representation rotating engine 212, which may include projected lane representations similar to the projected lane representation 502 illustrated in FIG. 7. FIG. 9A illustrates an example output of the lane representation rotating engine 212 in a simplified scenario with two iterations, in which the lane representation rotating engine 212 determines a rotation angle indicative of a heading error of an ego vehicle 802. FIG. 9B illustrates an example output of the lane representation rotating engine 212 in a scenario with three iterations. FIGS. 9C and 9D illustrate example intermediate outputs of the lane representation rotating engine 212 in a simplified scenario with two iterations.

In FIG. 8, two fully qualified iterations, following generation and projection of lane representations in each iteration, are provided to the lane representation rotating engine 212. A first iteration at a time t₂ includes an ego vehicle 802 and a lane representation that includes a left lane boundary representation L_{L}(t₂) and/or a right lane boundary representation L_{R}(t₂). In some embodiments, time t₂ may refer to a current iteration. At time t₂ the ego vehicle 802 may have a position, as obtained by a localization result, of P(t₂), which may be a position of a rear axle of the ego vehicle 802. A distance from the ego vehicle 802 position to a lane boundary (e.g., the left lane boundary representation L_{L}(t₂)) may be represented as a difference, or distance, between P(t₂) and P_{L}(t₂). P_{L}(t₂) may be a point, or position, on the left lane boundary representation L_{L}(t₂), at which the distance between P(t₂) and P_{L}(t₂) is minimized compared to a distance between P(t₂) and any other position on the left lane boundary representation L_{L}(t₂). In some embodiments, an orientation of a connecting segment between P(t₂) and P_{L}(t₂) may be orthogonal to an assumed heading or pose of the ego vehicle 802. In some embodiments, the ego vehicle 802 may be assumed to be positioned in a middle of the lane representation. In other words, a lateral distance between the ego vehicle 802 and the left lane boundary representation L_{L}(t₂) may be equal or approximately equal to a lateral distance between the ego vehicle 802 and the right lane boundary representation R_{L}(t₂). In other embodiments, if the ego vehicle 802 is not assumed to be positioned in a middle of the lane representation, other adjustments may be applied to the positions of left lane boundary representation L_{L}(t₂) and/or the right lane boundary representation R_{L}(t₂). For example, the left lane boundary representation L_{L}(t₂) and/or the right lane boundary representation R_{L}(t₂) may be shifted so that the ego vehicle is positioned in the middle of the lane representation.

A second iteration at a time t₁ includes the ego vehicle 802 and a lane representation that includes a left lane boundary representation L_{L}(t₁) and/or a right lane boundary representation L_{R}(t₁). In some embodiments, time t₁ may refer to a most recent previous iteration relative to time t₂. At time t₁ the ego vehicle 802 may have a position, as obtained by a localization result, of P(t₁), which may be a position of a rear axle of the ego vehicle 802. A distance from the ego vehicle 802 position to a lane boundary (e.g., the left lane boundary representation L_{L}(t₁)) may be represented as a difference, or distance, between P(t₁) and P_{L}(t₁). P_{L}(t₁) may be a point, or position, on the left lane boundary representation L_{L}(t₁), at which the distance between P(t₁) and P_{L}(t₁) is minimized compared to a distance between P(t₁) and any other position on the left lane boundary representation L_{L}(t₁). In some embodiments, an orientation of a connecting segment between P(t₁) and P_{L}(t₁) may be orthogonal to an estimated heading or pose of the ego vehicle 802.

In FIG. 9A, the lane representation rotating engine 212 determines a rotation angle θ to rotate the left lane boundary representation L_{L}(t₂) about, or with respect to, the position P_{L}(t₂), such that a function is satisfied. In some embodiments, the left lane boundary representation L_{L}(t₂) may be extended prior to rotation. A resulting rotated left lane boundary representation, following rotation by the rotation angle, is represented as a dashed line L_{Lθ}(t₂). In some embodiments, satisfaction of the function may include minimization of the function (e.g., an absolute value of the function), and/or minimization of a cost associated with the function. In some embodiments, the function, or the associated cost, may be represented as a difference between a first distance and a second distance. The first distance may be a distance between P(t₁) and P_{Lθ}(t₂) (e.g., the resulting rotated left lane boundary representation). P_{Lθ}(t₂) may be point, or position, on the resulting rotated left lane boundary representation L_{Lθ}(t₂) at which the distance between P(t₁) and P_{Lθ}(t₂) is minimized compared to a distance between P(t₁) and any other position on the resulting rotated left lane boundary representation L_{Lθ}(t₂). The second distance may be a distance between P(t₁) and P_{L}(t₁). Thus, the lane representation rotating engine 212 may iteratively determine the rotation angle to minimize the difference between the first distance and the second distance. This iterative process may be separate and independent from the previously described iteration related to capturing of lane indicia.

In some embodiments, given a line represented by ax+by=c, a center of rotation (x₀, y₀) which may correspond to the position P_{L}(t₂), and the rotation angle θ, the rotated line according to the rotation angle θ may be represented as Ax+By+C, where:

$$A = a cos ( ⊖ ) + b cos ( ⊖ ) ;$$

$$B = - a sin ( ⊖ ) + b cos ( ⊖ ) ; and$$

$$C = c + a ( {x}_{0} cos ( ⊖ ) - {y}_{0} sin ( ⊖ ) - {x}_{0} ) + b ( {x}_{0} sin ( ⊖ ) + {y}_{0} cos ( ⊖ ) - {y}_{0} )$$

FIG. 9B illustrates an implementation of the lane representation rotating engine 212, in a scenario with three iterations. FIG. 9B illustrates one example of how determining the rotation angle may be extended to a scenario with more than two iterations. Relevant principles illustrated in FIG. 9A, along with previous and subsequent FIGS., are also applicable to FIG. 9B. In FIG. 9B, in addition to the previously illustrated iterations corresponding to times t₂ and t₁, a third iteration corresponding to a time t₀ is also illustrated. The third iteration includes the ego vehicle 802 and a lane representation that includes a left lane boundary representation L_{L}(t₀) and/or a right lane boundary representation L_{R}(t₀). In some embodiments, time t₀ may refer to a most recent previous iteration relative to time t₁. At time t₀ the ego vehicle 802 may have a position, as obtained by a localization result, of P(t₀), which may be a position of a rear axle of the ego vehicle 802. A distance from the ego vehicle 802 position to a lane boundary (e.g., the left lane boundary representation L_{L}(t₀)) may be represented as a difference, or distance, between P(t₀) and P_{L}(t₀). P_{L}(t₀) may be a point, or position, on the left lane boundary representation L_{L}(t₀), at which the distance between P(t₀) and P_{L}(t₀) is minimized compared to a distance between P(t₀) and any other position on the left lane boundary representation L_{L}(t₀). In some embodiments, an orientation of a connecting segment between P(t₀) and P_{L}(t₀) may be orthogonal to an estimated heading or pose of the ego vehicle 802.

In FIG. 9B, the lane representation rotating engine 212 determines a rotation angle θ to rotate the left lane boundary representation L_{L}(t₂) about, or with respect to, the position P_{L}(t₂), such that a function is satisfied. In some embodiments, the left lane boundary representation L_{L}(t₂) may be extended prior to rotation. A resulting rotated left lane boundary representation, following rotation by the rotation angle, is represented as a dashed line L_{Lθ}(t₂). In some embodiments, satisfaction of the function may include minimization of the function, and/or minimization of a cost associated with the function. In some embodiments, the function, or the associated cost, may be represented as summation of a first difference and a second difference (e.g., represented mathematically as “first difference+second difference”). The first difference may correspond to the iteration at time t₁, and be the difference between the first distance and the second distance analogous to that previously described in FIG. 9A. As applied to FIG. 9B, the first distance may be a distance between P(t₁) and P_{L1θ}(t₂) (e.g., the resulting rotated left lane boundary representation). P_{L1θ}(t₂) may be point, or position, on the resulting rotated left lane boundary representation L_{Lθ}(t₂) at which the distance between P(t₁) and P_{L1θ}(t₂) is minimized compared to a distance between P(t₁) and any other position on the resulting rotated left lane boundary representation L_{Lθ}(t₂). The second distance may be a distance between P(t₁) and P_{L}(t₁).

The second difference may correspond to the iteration at time t₀, and be a difference between a third distance and a fourth distance. The third distance may be a distance between P(t₀) and P_{L2θ}(t₂) (e.g., the resulting rotated left lane boundary representation). P_{L2θ}(t₂) may be point, or position, on the resulting rotated left lane boundary representation L_{Lθ}(t₂) at which the distance between P(t₀) and P_{L2θ}(t₂) is minimized compared to a distance between P(t₀) and any other position on the resulting rotated left lane boundary representation L_{Lθ}(t₂). The fourth distance may be a distance between P(t₀) and P_{L}(t₀). In some embodiments, the fourth distance may be assumed to be equal, or approximately equal, to the second distance. The principle illustrated in FIG. 9B may also be extended to scenarios having more than three iterations, for example, by summing the differences at each corresponding iteration.

FIG. 9C illustrates an implementation of the lane representation rotating engine 212, in a scenario with two iterations, in which the lane representation rotating engine 212 determines a rotation angle θᵤ which does not yet satisfy the function. In FIG. 9C, the lane representation rotating engine 212 may continue to iterate by increasing the rotation angle from θᵤ until the function is satisfied.

FIG. 9D illustrates an implementation of the lane representation rotating engine 212, in a scenario with two iterations, in which the lane representation rotating engine 212 determines a rotation angle θₒ which does not satisfy the function. In FIG. 9D, the lane representation rotating engine 212 may have overadjusted, or determined a value of the rotation angle that is too large. This may happen if the lane representation rotating engine 212 initially iterates using a large step size. Thus, the lane representation rotating engine 212 may iterate by decreasing the rotation angle from θₒ until the function is satisfied.

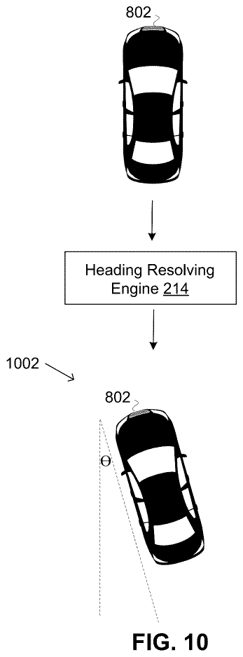

FIG. 10 illustrates an implementation of the heading resolving engine 214. The heading resolving engine 214 may generate or determine an updated heading representation 1002 of the ego vehicle 802, in accordance with the determined rotation angle θ. The updated heading representation 1002 may correct for errors in the previously estimated pose of the ego vehicle 802.

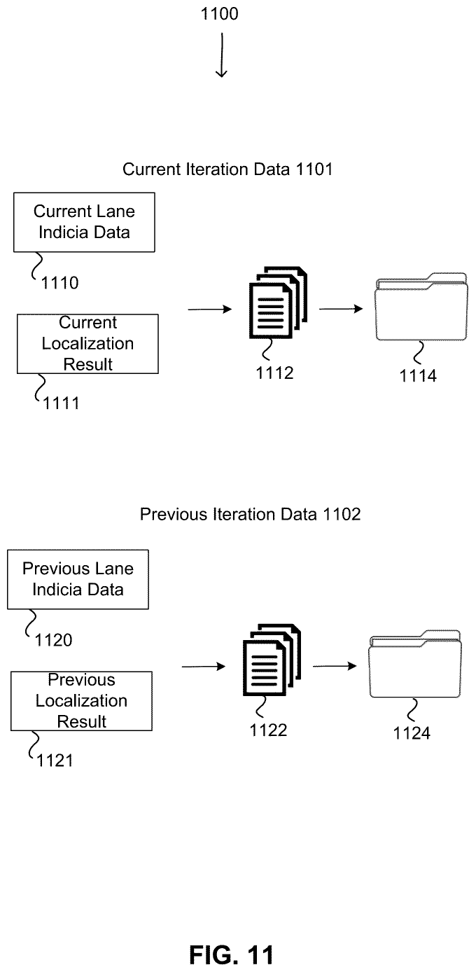

FIG. 11 illustrates an example implementation 1100 of storing and/or retaining iteration data corresponding to different iterations, such as a current iteration and a previous iteration. The implementation 1100 may include storing at least temporarily within the database 130 and/or within the storage 114. The iteration data includes current iteration data 1101 (e.g., corresponding to time t₂ in FIG. 9A) and/or previous iteration data 1102 (e.g., corresponding to time t₁ in FIG. 9A and/or time t⁰ in FIG. 9B). The current iteration data 1101 may include current lane indicia data 1110, which may be implemented as any of the lane indicia data 140, any characterization and/or qualification results as illustrated in FIG. 4, any generated and/or projected representations illustrated in FIGS. 5 and 7, and/or any determined rotation angles as illustrated in FIGS. 9A-9D. The current iteration data 1101 may further include a current localization result 1111, which indicates a pose of the ego vehicle 802 at time t₂. The current lane indicia data 1110 and/or the current localization result 1111 may be normalized in format, transformed, and/or merged into one or more datasets 1112, such as files, which may be partitioned into one or more directories 1114 (e.g., folders). The datasets 1112 and/or the directories 1114 may be part of the database 130 and/or the storage 114.

Similarly, the previous iteration data 1102 may include previous lane indicia data 1120, which may be implemented as any of the lane indicia data 140, any characterization and/or qualification results as illustrated in FIG. 4, any generated and/or projected representations illustrated in FIGS. 5 and 7, and/or any determined rotation angles as illustrated in FIGS. 9A-9D. The previous iteration data 1102 may further include a previous localization result 1121, which indicates a previous pose of the ego vehicle 802 (e.g., at time t₁ or a time t₀). The previous lane indicia data 1120 and/or the previous localization result 1121 may be normalized in format, transformed, and/or merged into one or more datasets 1122, such as files, which may be partitioned into one or more directories 1124 (e.g., folders). The datasets 1122 and/or the directories 1124 may be part of the database 130 and/or the storage 114.

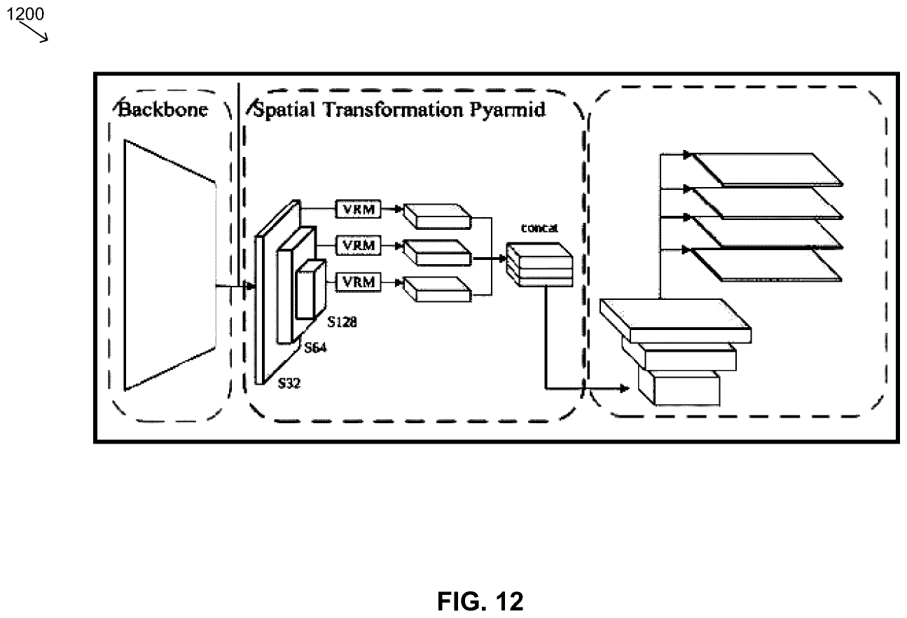

FIG. 12 illustrates an example representation 1200 of a neural network component which may be used to obtain or predict lane indicia. In some embodiments, raw lane indicia data (e.g., 140) may be processed by one or more neural network components in order to refine an inference of lane indicia. Such neural network components may include, for example, a backbone configured to generate embeddings that are passed through a Spatial Transformation Pyramid or a Feature Pyramid Network (FPN). In some embodiments, the neural network component may be associated with the computing system 102.

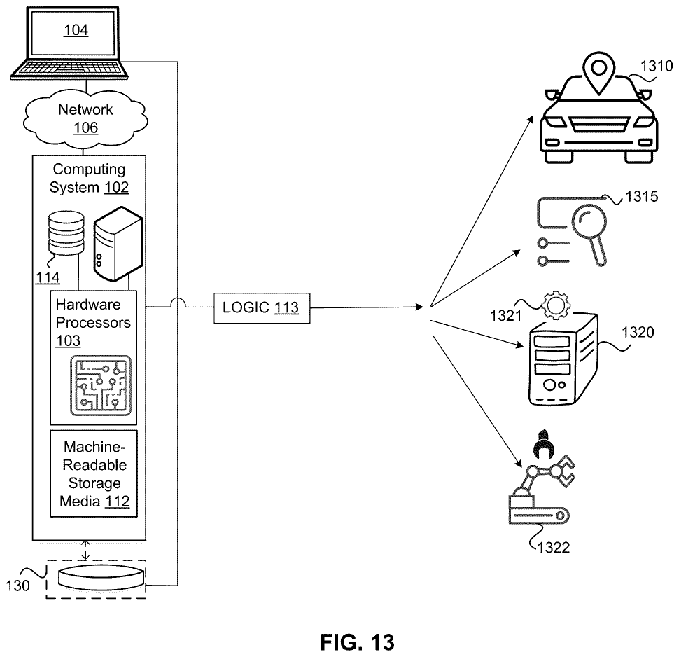

FIG. 13 illustrates downstream actions following the resolving of a heading. These downstream actions may be part of a workflow or a process. The downstream actions may encompass performing navigation 1310, additional monitoring 1315, transmitting and/or writing information to a different computing system 1320, for example, via an API 1321, and/or maintenance or other physical operations 1322 such as adjusting a physical or electronic infrastructure of a vehicle in order to better react to certain safety conditions.

As an example of the additional monitoring 1315, the computing system 102 and/or a different computing system may monitor safety-related parameters such as interaction and speed-related parameters of an ego vehicle, and component parameters such as sensor parameters or tire parameters, to verify whether the safety-related parameters fall within certain operating thresholds. In some examples, the additional monitoring 1315 may occur in response to certain safety-related parameters falling outside of certain operating ranges or thresholds. An example of transmitting and/or writing information to a different computing system 1320 may include an alert and/or a notification to the computing device 104 and/or to other devices. The alert may indicate which safety-related parameters have fallen outside of operating ranges or thresholds. Alternatively, an alert may be triggered to indicate a predicted time at which a safety-related parameter may fall outside of an operating range or threshold.

In yet other examples, a downstream action may entail an applications programming interface (API) 121 of the computing system 102 interfacing with or calling the API 1321 of the different computing system 1320. For example, the different computing system 1320 may perform analysis and/or transformation or modification of data, through some electronic or physical operation. Meanwhile, the physical operations 1322 may include controlling braking, steering, and/or throttle components to effectuate a throttle response, a braking action, and/or a steering action during navigation, and/or activation of other vehicle components.

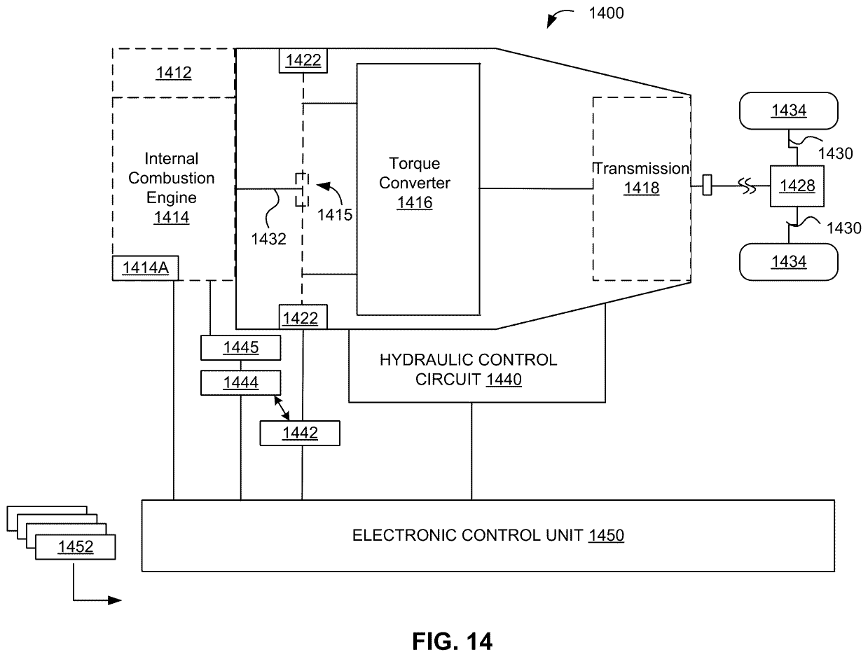

The systems and methods disclosed herein may be implemented with any of a number of different ego vehicles and ego vehicle types. For example, the systems and methods disclosed herein may be used with automobiles, trucks, motorcycles, recreational vehicles and other like on- or off-road vehicles. In addition, the principles disclosed herein may also extend to other vehicle types as well. An example hybrid electric vehicle (HEV) in which embodiments of the disclosed technology may be implemented as an ego vehicle and is illustrated in FIG. 14. Although the example described with reference to FIG. 14 is a hybrid type of ego vehicle, the systems and methods for adaptive and selective extraction of media data can be implemented in other types of ego vehicles including gasoline- or diesel-powered vehicles, fuel-cell vehicles, electric vehicles, or other vehicles.

FIG. 14 illustrates a drive system of an ego vehicle 1400 that may include an internal combustion engine 1414 and one or more electric motors 1422 (which may also serve as generators) as sources of motive power. The ego vehicle 1400 may be implemented as any of the previously described ego vehicles. Driving force generated by the internal combustion engine 1414 and motors 1422 can be transmitted to one or more wheels 1434 via a torque converter 1416, a transmission 1418, a differential gear device 1428, and a pair of axles 1430.

As an HEV, ego vehicle 1400 may be driven/powered with either or both of engine 1414 and the motor(s) 1422 as the drive source for travel. For example, a first travel mode may be an engine-only travel mode that only uses internal combustion engine 1414 as the source of motive power. A second travel mode may be an EV travel mode that only uses the motor(s) 1422 as the source of motive power. A third travel mode may be an HEV travel mode that uses engine 1414 and the motor(s) 1422 as the sources of motive power. In the engine-only and HEV travel modes, ego vehicle 1400 relies on the motive force generated at least by internal combustion engine 1414, and a clutch 1415 may be included to engage engine 1414. In the EV travel mode, ego vehicle 1400 is powered by the motive force generated by motor 1422 while engine 1414 may be stopped and clutch 1415 disengaged.

Engine 1414 can be an internal combustion engine such as a gasoline, diesel or similarly powered engine in which fuel is injected into and combusted in a combustion chamber. A cooling system 1412 can be provided to cool the engine 1414 such as, for example, by removing excess heat from engine 1414. For example, cooling system 1412 can be implemented to include a radiator, a water pump and a series of cooling channels. In operation, the water pump circulates coolant through the engine 1414 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 1414. In other applications, either or both the water pump and the fan may be operated by electric current such as from battery 1444.

An output control circuit 1414A may be provided to control drive (output torque) of engine 1414. Output control circuit 1414A may include a throttle actuator to control an electronic throttle valve that controls fuel injection, an ignition device that controls ignition timing, and the like. Output control circuit 1414A may execute output control of engine 1414 according to a command control signal(s) supplied from an electronic control unit 1450, described below. Such output control can include, for example, throttle control, fuel injection control, and ignition timing control. In some embodiments, the electronic control unit 1450 may be implemented as part of any of the previously described computing systems, such as the computing system 102.

Motor 1422 can also be used to provide motive power in ego vehicle 1400 and is powered electrically via a battery 1444. Battery 1444 may be implemented as one or more batteries or other power storage devices including, for example, lead-acid batteries, nickel-metal hydride batteries, lithium-ion batteries, capacitive storage devices, and so on. Battery 1444 may be charged by a battery charger 1445 that receives energy from internal combustion engine 1414. For example, an alternator or generator may be coupled directly or indirectly to a drive shaft of internal combustion engine 1414 to generate an electrical current as a result of the operation of internal combustion engine 1414. A clutch can be included to engage/disengage the battery charger 1445. Battery 1444 may also be charged by motor 1422 such as, for example, by regenerative braking or by coasting during which time motor 1422 operate as generator.

Motor 1422 can be powered by battery 1444 to generate a motive force to move the vehicle and adjust vehicle speed. Motor 1422 can also function as a generator to generate electrical power such as, for example, when coasting or braking. Battery 1444 may also be used to power other electrical or electronic systems in the vehicle. Motor 1422 may be connected to battery 1444 via an inverter 1442. Battery 1444 can include, for example, one or more batteries, capacitive storage units, or other storage reservoirs suitable for storing electrical energy that can be used to power motor 1422. When battery 1444 is implemented using one or more batteries, the batteries can include, for example, nickel metal hydride batteries, lithium-ion batteries, lead acid batteries, nickel cadmium batteries, lithium ion polymer batteries, and other types of batteries.

An electronic control unit 1450 (described below) may be included and may control the electric drive components of the vehicle as well as other vehicle components. For example, electronic control unit 1450 may control inverter 1442, adjust driving current supplied to motor 1422, and adjust the current received from motor 1422 during regenerative coasting and breaking. As a more particular example, output torque of the motor 1422 can be increased or decreased by electronic control unit 1450 through the inverter 1442.

A torque converter 1416 can be included to control the application of power from engine 1414 and motor 1422 to transmission 1418. Torque converter 1416 can include a viscous fluid coupling that transfers rotational power from the motive power source to the driveshaft via the transmission. Torque converter 1416 can include a conventional torque converter or a lockup torque converter. In other embodiments, a mechanical clutch can be used in place of torque converter 1416.

Clutch 1415 can be included to engage and disengage engine 1414 from the drivetrain of the vehicle. In the illustrated example, a crankshaft 1432, which is an output member of engine 1414, may be selectively coupled to the motor 1422 and torque converter 1416 via clutch 1415. Clutch 1415 can be implemented as, for example, a multiple disc type hydraulic frictional engagement device whose engagement is controlled by an actuator such as a hydraulic actuator. Clutch 1415 may be controlled such that its engagement state is complete engagement, slip engagement, and complete disengagement complete disengagement, depending on the pressure applied to the clutch. For example, a torque capacity of clutch 1415 may be controlled according to the hydraulic pressure supplied from a hydraulic control circuit 1440. When clutch 1415 is engaged, power transmission is provided in the power transmission path between the crankshaft 1432 and torque converter 1416. On the other hand, when clutch 1415 is disengaged, motive power from engine 1414 is not delivered to the torque converter 1416. In a slip engagement state, clutch 1415 is engaged, and motive power is provided to torque converter 1416 according to a torque capacity (transmission torque) of the clutch 1415.

As alluded to above, ego vehicle 1400 may include an electronic control unit 1450. Electronic control unit 1450 may include circuitry to control various aspects of the vehicle operation. Electronic control unit 50 may include, for example, a microcomputer that includes a one or more processing units (e.g., microprocessors), memory storage (e.g., RAM, ROM, etc.), and I/O devices. The processing units of electronic control unit 1450 execute instructions stored in memory to control one or more electrical systems or subsystems in the vehicle. Electronic control unit 1450 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 14, electronic control unit 1450 receives information from a plurality of sensors included in ego vehicle 1400. For example, electronic control unit 1450 may receive signals that indicate vehicle operating conditions or characteristics, or signals that can be used to derive vehicle operating conditions or characteristics. These may include, but are not limited to accelerator operation amount, a revolution speed, of internal combustion engine 1414 (engine RPM), a rotational speed of the motor 1422 (motor rotational speed), and vehicle speed. These may also include torque converter 1416 output (e.g., output amps indicative of motor output), brake operation amount/pressure, battery state of charge (SOC) (i.e., the charged amount for battery 1444 detected by an SOC sensor). Accordingly, ego vehicle 1400 can include a plurality of sensors 1452 that can be used to detect various conditions internal or external to the vehicle (e.g., part of the sensor data 140) and provide sensed conditions to engine control unit 1450 (which, again, may be implemented as one or a plurality of individual control circuits). In one embodiment, sensors 1452 may be included to detect one or more conditions directly or indirectly such as, for example, fuel efficiency, motor efficiency, hybrid (internal combustion engine 1414+cooling system 1412) efficiency, acceleration, etc. Electronic control unit 1450 may also receive signals indicative of user behavior. Here, a user may refer to an occupant, such as a driver or a passenger. These signals may include, without limitation, a measure of head or eye movement. In some embodiments, certain user behavior may indicate anomalies in functioning of the ego vehicle 1400, which may trigger an update to the ODD.

In some embodiments, one or more of the sensors 1452 may include their own processing capability to compute the results for additional information that can be provided to electronic control unit 1450. In other embodiments, one or more sensors may be data-gathering-only sensors that provide only raw data to electronic control unit 1450. In further embodiments, hybrid sensors may be included that provide a combination of raw data and processed data to electronic control unit 1450. Sensors 1452 may provide an analog output or a digital output.

Sensors 1452 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect, for example, traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The sensors 1452 may be within an interior or on an exterior of the ego vehicle 1450. The sensors 1452 may also include capturing sensors, which capture media data within the ego vehicle 1400 or within surroundings of the ego vehicle 1400. In some embodiments, additional sensors may not be directly connected to the ego vehicle 1400, but rather, may be located on a different entity, such as a drone or a stationary landmark such as a traffic light.

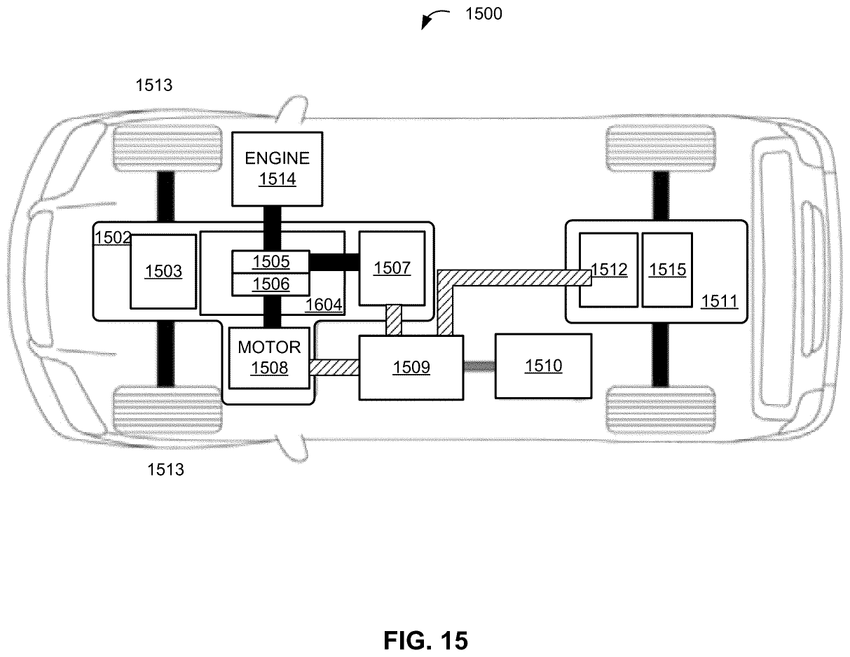

FIG. 15 is another example of an ego vehicle with which systems and methods described above can be implemented. The example illustrated in FIG. 15 is also that of a hybrid vehicle drive system of a vehicle 1500 that may also include an engine 1514 (e.g., internal combustion engine 1514) and one or more electric motors 1508, 1512 as sources of motive power. In this example, a hybrid transaxle assembly 1502 includes front differential 1503, a compound gear unit 1504, a motor 1508, and a generator 1507. Compound gear unit 1504 includes a power split planetary gear unit 1505 and a motor speed reduction planetary gear unit 1506. This example vehicle also includes front and rear drive motors 1508, 1512, an inverter with converter assembly 1509, battery 1510 (which may include multiple batteries), and a rear differential 1515. Hybrid transaxle assembly 1502 enables power from engine 1501, motor 1508, or both to be applied to front wheels 1513 via front differential 1503.

Inverter with converter assembly 1509 inverts DC power from battery 1510 to create AC power to drive AC motors 1508, 1512. In embodiments where motors 1508, 1512 are DC motors, no inverter is required. Inverter with converter assembly 1509 also accepts power from generator 1507 (e.g., during engine charging) and uses this power to charge battery 1510.

The examples of FIGS. 14 and 15 are provided for illustration purposes only as examples of vehicle systems with which embodiments of the disclosed technology may be implemented. One of ordinary skill in the art reading this description will understand how the disclosed embodiments can be implemented with vehicle platforms.

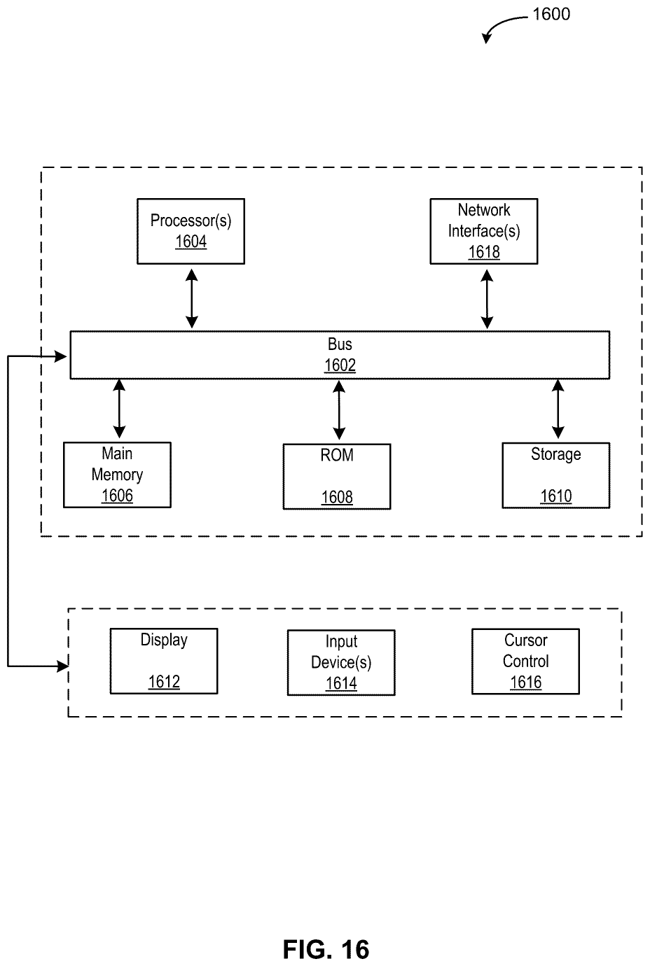

FIG. 16 illustrates a block diagram of a computer system 1600 upon which any of the embodiments described herein may be implemented. The computer system 1600 includes a bus 1602 or other communication mechanism for communicating information, one or more hardware or other processors, such as cloud processors, 1604 coupled with bus 1602 for processing information. A description that a device performs a task is intended to mean that one or more of the processor(s) 1604 performs.

The computer system 1600 also includes a main memory 1606, such as a random access memory (RAM), cache and/or other dynamic storage devices, coupled to bus 1602 for storing information and instructions to be executed by processor 1604. Main memory 1606 also may be used for storing temporary variables or other intermediate information during execution of instructions to be executed by processor 1604. Such instructions, when stored in storage media accessible to processor 1604, render computer system 1600 into a special-purpose machine that is customized to perform the operations specified in the instructions.

The computer system 1600 further includes a read only memory (ROM) 1608 or other static storage device coupled to bus 1602 for storing static information and instructions for processor 1604. A storage device 1610, such as a magnetic disk, optical disk, or USB thumb drive (Flash drive), etc., is provided and coupled to bus 1602 for storing information and instructions.

The computer system 1600 may be coupled via bus 1602 to output device(s) 1612, such as a cathode ray tube (CRT) or LCD display (or touch screen), for displaying information to a computer user. Input device(s) 1614, including alphanumeric and other keys, are coupled to bus 1602 for communicating information and command selections to processor 1604. Another type of user input device is cursor control 1616. The computer system 1600 also includes a communication interface 1618 coupled to bus 1602.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. Additionally, the singular forms “a,” “an” and “the” include plural referents unless the context clearly dictates otherwise. The phrases “at least one of,” “at least one selected from the group of,” or “at least one selected from the group consisting of,” and the like are to be interpreted in the disjunctive (e.g., not to be interpreted as at least one of A and at least one of B).

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment, but may be in some instances. Furthermore, the particular features, structures, or characteristics may be combined in any suitable manner in one or more embodiment.

A component being implemented as another component may be construed as the component being operated in a same or similar manner as the another component, and/or comprising same or similar features as the another component.

1. A computing system comprising:
one or more processors; and
a memory storing instructions that, when executed by the one or more processors, cause the computing system to perform:
obtaining, from one or more sensors, different iterations of lane indicia data, wherein each iteration of the lane indicia data comprises lane indicia indicative of a presence of a lane;
obtaining, from a different computing module, localization results comprising estimated poses of an ego vehicle corresponding to each of the different iterations;
characterizing the different iterations of the lane indicia data;
selectively qualifying the different iterations of the lane indicia data based on the characterization of the different iterations;
for each qualified iteration:
generating a lane representation based on the lane indicia data;
projecting the lane representation into a different coordinate system and projecting the localization result into the different coordinate system; and
for a pair of qualified iterations comprising a first qualified iteration and a second qualified iteration, iteratively determining, based on a function, a rotation angle of a first lane representation corresponding to the first qualified iteration with respect to a second lane representation corresponding to the second qualified iteration;
outputting a result of the rotation angle based on the function; and
resolving the localization result based on the result of the rotation.

2. The computing system of claim 1, wherein the characterizing of the different iterations comprises, for a particular iteration, determining whether the lane indicia corresponding to the particular iteration constitutes a sufficiently straight line segment or whether the lane indicia is fittable to a straight line segment.

3. The computing system of claim 2, wherein the selectively qualifying the different iterations comprises:
in response to determining that the lane indicia corresponding to the particular iteration constitutes a sufficiently straight line segment or whether the lane indicia is fittable to a straight line segment, qualifying the particular iteration; and
in response to determining that the lane indicia corresponding to the particular iteration fails to constitute a sufficiently straight line segment or that the lane indicia is unfittable to a straight line segment, disqualifying the particular iteration.

4. The computing system of claim 1, wherein the qualifying of the different iterations is based on implementing of a distance filter, the implementing of the distance filter comprising:
if a distance between a most recent iteration and a closest previous qualified iteration is within a threshold range of distances, qualifying the most recent iteration; and
if a distance between the most recent iteration and the closest previous qualified iteration is outside of the threshold range, disqualifying the most recent iteration.

5. The computing system of claim 1, wherein generating of the lane representation comprises generating a connecting lane segment that connects the lane indicia.

6. The computing system of claim 1, wherein the different iterations of lane indicia data are captured with respect to a sensor coordinate system; and the different coordinate system comprises a world coordinate system.

7. The computing system of claim 1, wherein:
the estimated poses comprises a first ego vehicle location corresponding to the first qualified iteration and a second ego vehicle location corresponding to the second qualified iteration;
the function comprises a difference between a first distance and a second distance;
the first distance comprises a distance between the second ego vehicle location and a resulting rotated first lane representation when the first lane representation is rotated by the rotation angle;
the second distance comprises a distance between the second ego vehicle location and the second lane representation; and
iteratively determining the rotation angle comprises determining the rotation angle that minimizes the function.

8. The computing system of claim 7, wherein:
the first distance comprises a distance between the second ego vehicle location and a first particular point within the resulting rotated first lane representation, wherein the first particular point is selected, such that, a distance between the second ego vehicle location and the first particular point is smaller than a distance between the second ego vehicle location and any other point within the resulting rotated first lane representation; and
the second distance comprises a distance between the second ego vehicle location and a second particular point within the second lane representation, wherein the second particular point is selected, such that, a distance between the second ego vehicle location and the second particular point is smaller than a distance between the second ego vehicle location and any other point within the second lane representation.

9. The computing system of claim 1, wherein a segment connecting the second ego vehicle location to the second particular point is orthogonal to the estimated pose of the ego vehicle at the second ego vehicle location.

10. The computing system of claim 1, wherein the first qualified iteration corresponds to a most recent iteration and the second qualified iteration corresponds to a previous iteration.

11. A method implemented by one or more processors of a computing system, the method comprising:
obtaining, from one or more sensors, different iterations of lane indicia data, wherein each iteration of the lane indicia data comprises lane indicia indicative of a presence of a lane;
obtaining, from a different computing module, localization results comprising estimated poses of an ego vehicle corresponding to each of the different iterations;
characterizing the different iterations of the lane indicia data;
selectively qualifying the different iterations of the lane indicia data based on the characterization of the different iterations;
for each qualified iteration:
generating a lane representation based on the lane indicia data;
projecting the lane representation into a different coordinate system and projecting the localization result into the different coordinate system; and
for a pair of qualified iterations comprising a first qualified iteration and a second qualified iteration, iteratively determining, based on a function, a rotation angle of a first lane representation corresponding to the first qualified iteration with respect to a second lane representation corresponding to the second qualified iteration;
outputting a result of the rotation angle based on the function; and
resolving the localization result based on the result of the rotation.

12. The method of claim 11, wherein the characterizing of the different iterations comprises, for a particular iteration, determining whether the lane indicia corresponding to the particular iteration constitutes a sufficiently straight line segment or whether the lane indicia is fittable to a straight line segment.

13. The method of claim 12, wherein the selectively qualifying the different iterations comprises:
in response to determining that the lane indicia corresponding to the particular iteration constitutes a sufficiently straight line segment or whether the lane indicia is fittable to a straight line segment, qualifying the particular iteration; and
in response to determining that the lane indicia corresponding to the particular iteration fails to constitute a sufficiently straight line segment or that the lane indicia is unfittable to a straight line segment, disqualifying the particular iteration.

14. The method of claim 11, wherein the qualifying of the different iterations is based on implementing of a distance filter, the implementing of the distance filter comprising:
if a distance between a most recent iteration and a closest previous qualified iteration is within a threshold range of distances, qualifying the most recent iteration; and
if a distance between the most recent iteration and the closest previous qualified iteration is outside of the threshold range, disqualifying the most recent iteration.

15. The method of claim 11, wherein generating of the lane representation comprises generating a connecting lane segment that connects the lane indicia.

16. The method of claim 11, wherein:
the different iterations of lane indicia data are captured with respect to a sensor coordinate system; and
the different coordinate system comprises a world coordinate system.

17. The method of claim 11, wherein:
the estimated poses comprises a first ego vehicle location corresponding to the first qualified iteration and a second ego vehicle location corresponding to the second qualified iteration;
the function comprises a difference between a first distance and a second distance;
the first distance comprises a distance between the second ego vehicle location and a resulting rotated first lane representation when the first lane representation is rotated by the rotation angle;
the second distance comprises a distance between the second ego vehicle location and the second lane representation; and
iteratively determining the rotation angle comprises determining the rotation angle that minimizes the function.

18. The method of claim 17, wherein:
the first distance comprises a distance between the second ego vehicle location and a first particular point within the resulting rotated first lane representation, wherein the first particular point is selected, such that, a distance between the second ego vehicle location and the first particular point is smaller than a distance between the second ego vehicle location and any other point within the resulting rotated first lane representation; and
the second distance comprises a distance between the second ego vehicle location and a second particular point within the second lane representation, wherein the second particular point is selected, such that, a distance between the second ego vehicle location and the second particular point is smaller than a distance between the second ego vehicle location and any other point within the second lane representation.

19. The method of claim 11, wherein a segment connecting the second ego vehicle location to the second particular point is orthogonal to the estimated pose of the ego vehicle at the second ego vehicle location.

20. The method of claim 11, wherein the first qualified iteration corresponds to a most recent iteration and the second qualified iteration corresponds to a previous iteration.
